(19) United States
(12) Patent Application Publication
(10) Pub. No.: US 2020/0152017 A1
(43) Pub. Date: May 14, 2020

(54) Gaming Methods and Apparatus Facilitating Tournament Play at Gaming Machines

(71) Applicant: Everi Games, Inc., Austin, TX (US)

(72) Inventors: John Carpenter, Austin, TX (US); Brian Watkins, Austin, TX (US); Allison Pope, Austin, TX (US); Loren Jacobs, Austin, TX (US); Keith Riggs, Austin, TX (US)

(73) Assignee: Everi Games, Inc., Austin, TX (US)

(21) Appl. No.: 16/746,886

(22) Filed: Jan. 19, 2020

Related U.S. Application Data
(62) Division of application No. 15/716,468, filed on Sep. 26, 2017, now abandoned.
(60) Provisional application No. 62/400,052, filed on Sep. 26, 2016.

(51) Int. Cl. G07F 17/32

(52) U.S. Cl. CPC G07F 17/3276; G07F 17/3288; G07F 17/3262; G07F 17/3223

(57) ABSTRACT

Methods facilitate tournaments in which tournament players play their tournament rounds at different times rather than concurrently as in a standard tournament. These methods may include monitoring for a player who is qualified tournament play. This monitoring is conducted by a tournament controller and may involve determining if one or more qualifying parameter values associated with a communication from a gaming machine satisfy a qualifying parameter definition which may be set by a system operator via the tournament controller. Where a tournament-qualified player is detected at a gaming machine, that gaming machine is enabled for play of a tournament game. The tournament game may then be conducted through the gaming machine to produce a tournament score for the player. This score is stored in memory associated with the tournament controller along with scores similarly produced for other qualified players.

### CROSS-REFERENCE TO RELATED APPLICATION

This application claims the benefit, under 35 U.S.C. § 119(e), of U.S. Provisional Patent Application No. 62/400,052 filed Sep. 26, 2016 and entitled “Convertible In-Revenue and Out-of-Revenue Gaming System.” The entire content of this provisional application is incorporated herein by this reference. The entire content of U.S. Pat. No. 9,443,394 entitled “Convertible In-Revenue and Out-of-Revenue Gaming System and Method with a Real-Time Streaming Video Feed and Display” is also incorporated herein by this reference.

This application claims the benefit, under 35 U.S.C. § 120, of U.S. patent application Ser. No. 15/716,468 filed Sep. 26, 2017 and entitled “Gaming Methods and Apparatus Facilitating Tournament Play at Gaming Machines Which Are Configurable to Accept Wagers.” The entire content of this prior application is incorporated herein by this reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the U.S. Patent and Trademark Office patent files or records, but otherwise reserves all rights of copyright whatsoever.

### TECHNICAL FIELD OF THE INVENTION

This invention relates to wagering games, gaming machines, gaming systems, and associated methods. More particularly, the invention relates to gaming machines, systems, and related methods.

### BACKGROUND OF THE INVENTION

Various gaming systems have been developed to provide in-revenue and out-of-revenue gaming machines and systems. Most of those systems are either dedicated to in-revenue operation or out-of-revenue operation. An example of in-revenue operation is where play at a gaming machine or system is initiated with a money (or equivalent) wager by a player. An example of out-of-revenue operation is where game play at a gaming machine or system does not require a wager (e.g. tournament or free play).

There continues to be a need for innovative methods and gaming systems which provide convertibility between in-revenue and out-of-revenue gaming operation. There is also a need for innovative methods and systems for presenting tournament games in different ways to generate player interest and excitement.

### SUMMARY OF THE INVENTION

Methods according to the various aspects of the present invention are directed to networked gaming systems which include a number of networked gaming machines. A method according to one aspect of the present invention is directed in particular to a tournament gaming system which defines a number of one or more first level rounds at a first level of a tournament and one or more second level rounds at a second level of the tournament. The tournament system further defines criteria for player advancement from the first level rounds to the second level rounds. A method according to this aspect of the invention includes conducting the first level rounds among a number of tournament players, with each tournament player participating at one of the set of networked gaming machines. The conduct of the first level rounds identifies a set of non-advancing tournament players and identifies one or more advancing tournament players. Each non-advancing tournament player comprises a tournament player who has not met the criteria for player advancement from the first level rounds to the second level rounds and each advancing player comprises a player who has met the criteria for player advancement. After identifying the non-advancing tournament players, a method according to this aspect of the invention includes making a selection of one or more players from the set of non-advancing tournament players. One or more of these selected non-advancing tournament players are added to a set of one or more advancing tournament players for advancement to the second level rounds of the tournament.

In some implementations according to this aspect of the invention, the selection of one or more players from the set of non-advancing tournament players includes making an initial random selection of two or more players from the set of non-advancing tournament players, and then conducting a wild card drawing between those players. The wild card drawing operates to identify the one or more players from the set of non-advancing tournament players for adding to the set advancing tournament players for advancement to the second level rounds of the tournament.

Other implementations according to this first aspect of the invention an alternative process for the selection of one or more players from the set of non-advancing tournament players. In these implementations the selection includes making an initial random selection of two or more players from the set of non-advancing tournament players and then conducting a wild card round between those players. In this case it is the result of the wild card round of one or more games which is used to identify players from the set of non-advancing tournament players for adding to the advancing tournament players for advancement to the second level rounds of the tournament.

Implementations according to this first aspect of the invention may also include steps of configuring the gaming system for the wild card advancement of players who would not otherwise advance to the next round in the tournament. In particular, these methods may include displaying a wild card configuration interface at a tournament controller and receiving a selection for wild card advancement in the tournament through the wild card configuration interface. Identifying the non-advancing tournament players and making a selection of one or more of those players is then performed in response to the selection for wild card advancement in the tournament.

Methods according to a second aspect of the invention apply to “sit-and-go” (abbreviated “sit/go” herein) tournaments in which tournament players play their tournament rounds at different times rather than concurrently as in a standard tournament. These methods may include monitoring for a qualified player for the sit/go tournament. This monitoring is conducted by a tournament controller and may involve determining if one or more qualifying parameter values associated with a communication from a gaming machine satisfy a qualifying parameter definition which may be set by a system operator via the tournament controller. Where a sit/go tournament-qualified player is detected at a gaming machine, that gaming machine is enabled for sit/go tournament play for a tournament game. The sit/go tournament game may then be conducted through the gaming machine to produce a tournament score for the player. This score is stored in memory associated with the tournament controller along with scores similarly produced for other qualified players. Methods according to this aspect of the invention may further include reading one or more scores from previously conducted tournament play in the tournament game from a stored score data storage device, and, during sit/go tournament play at the gaming machine, displaying the one or more scores from the previously conducted tournament play in the tournament game.

A method according to a third aspect of the present invention includes using an operator interface associated with a tournament controller to define a qualification parameter for a tournament qualification tier. In response to receiving a player's registration request for a tournament, the method includes comparing a parameter associated with the registration request to the qualification parameter for the tournament qualification tier. The player is then registered into a tournament associated with the tournament qualification tier in the event of a match between the parameter associated with the registration request and the qualification parameter.

A method according to a fourth aspect of the present invention is directed to assisting tournament players locate the tournament gaming machines to which they have been assigned for tournament play. A method according to this aspect includes assigning a gaming machine bank and unique first identifier for the bank, and then communicating an instruction to the gaming machine bank to display the unique first identifier. Methods according to this fourth aspect include assigning a second unique identifier to a respective gaming machine in the gaming machine bank and communicating an instruction to the respective gaming machine to display the second unique identifier. A player is then assigned to the respective gaming machine and both the first unique identifier and the second unique identifier are communicated to the player so that the player may more easily locate the assigned gaming machine.

Methods according to a fifth aspect of the present invention relate to facilitating tournament play in the course of normal in-revenue gaming. Methods according to this aspect of the invention include receiving a wager for each activation for a play in a respective game conducted on a respective gaming machine in a group of networked gaming machines operating in a wagering game mode. A portion of each of these wagers is placed into a tournament prize fund. In the course of this normal in-revenue play at the gaming machines, a trigger event may occur which causes each gaming machine of the group which meets an eligibility requirement to be placed in a tournament game mode to provide a tournament game for a predefined tournament time period. Activations of the tournament game at each of the converted tournament game mode gaming machines are then received over the course of the tournament period and a respective tournament score is maintained for each of these gaming machines. Responsive to an end of the tournament time period, these methods include paying a respective tournament prize for each tournament score identified as a prize-winning score. Each of these prizes is paid from the tournament prize fund. Ultimately, each gaming machine which had been placed in the tournament game mode are returned to the wagering game mode for further play in that mode.

These and other advantages and features of the invention will be apparent from the following description of illustrative embodiments, considered along with the accompanying drawings.

### BRIEF DESCRIPTION OF THE DRAWINGS

FIG. 1 illustrates an example convertible in-revenue and out-of-revenue game system shown with a control center server controlling a bank of gaming machines with respective game themes, such as during an in-revenue gaming operating mode, in accordance with one or more embodiments.

FIG. 2 illustrates an example convertible in-revenue and out-of-revenue gaming system with a bank of gaming machines with respective game themes, such as during an in-revenue gaming operating mode, and a connected overhead display showing an example tournament advertising banner TOURNEVENT® in accordance with one or more embodiments.

FIG. 3 comprises a side view of an example convertible in-revenue and out-of-revenue gaming system with two back-to-back banks of gaming machines with respective game themes, such as during an in-revenue gaming operating mode, and a connected overhead display in accordance with one or more embodiments.

FIG. 4 illustrates an example front view of a convertible gaming machine with a camera and a secondary display with an example tournament advertising banner in accordance with one or more embodiments.

FIG. 5 illustrates an example logical layout of a convertible gaming machine in accordance with one or more embodiments.

FIG. 6 illustrates another example bank of gaming machines with an overhead display showing an example real-time tournament or community game leader board and player video feed in accordance with one or more embodiments.

FIG. 7 illustrates an example tournament control screenshot displayable at a user interface console of a control center server controlling one or more banks of gaming machines in accordance with one or more embodiments.

FIG. 8 illustrates an example active tournaments control screenshot displayable at a user interface console of a control center server controlling one or more banks of gaming machines in accordance with one or more embodiments.

FIG. 9 illustrates an example text floor view screenshot displayable at a user interface console of a control center server controlling one or more banks of gaming machines in accordance with one or more embodiments.

FIG. 10 illustrates an example advertisement manager screenshot displayable at a user interface console of a control center server controlling one or more banks of gaming machines in accordance with one or more embodiments.

FIG. 11 illustrates an example file manager screenshot displayable at a user interface console of a control center server controlling one or more banks of gaming machines in accordance with one or more embodiments.

FIG. 12 illustrates an example tournament configuration screenshot displayable at a user interface console of a control center server controlling one or more banks of gaming machines in accordance with one or more embodiments.

FIG. 13 illustrates an example graphic floor view screenshot displayable at a user interface console of a control center server controlling one or more banks of gaming machines in accordance with one or more embodiments.

FIG. 14 illustrates an example tournament details screenshot displayable at a user interface console of a control center server controlling one or more banks of gaming machines in accordance with one or more embodiments.

FIG. 15 illustrates an example quick tournament screenshot displayable at a user interface console of a control center server controlling one or more banks of gaming machines in accordance with one or more embodiments.

FIG. 16 illustrates an example player search screenshot displayable at a user interface console of a control center server controlling one or more banks of gaming machines in accordance with one or more embodiments.

FIG. 17 illustrates an example player station assignments screenshot displayable at a user interface console of a control center server controlling one or more banks of gaming machines in accordance with one or more embodiments.

FIG. 18 comprises a schematic representation of tournament or competition-style gaming system in accordance with one or more embodiments.

FIG. 19A is a flow diagram showing a portion of a wild card advancement configuration process.

FIG. 19B is a flow diagram showing an additional portion of a wild card advancement configuration process.

FIG. 20 is a flow diagram showing a sit and go tournament configuration process.

FIG. 21 is a flow diagram showing a tournament play record collection process for collecting tournament play records for use in a sit and go tournament.

FIG. 22 is a flow diagram showing a sit and go tournament process.

FIG. 23 is a flow diagram showing a tournament tier qualification configuration process.

FIG. 24 is a representation of a tier selection drop down menu.

FIG. 25 is a flow diagram of a process for configuring a tournament gaming system to assist players in locating their assigned gaming machines.

FIG. 26 is a representation of a bank of gaming machines configurable according to the process of FIG. 25.

FIG. 27 is a representation of the bank of gaming machines shown in FIG. 26 after being configured to assist players in locating their assigned gaming machine.

FIG. 28 is a representation of the bank of gaming machines shown in FIG. 26 after a tournament countdown has started.

FIG. 29 is a representation of the bank of gaming machines shown in FIG. 26 after a tournament play has started.

FIG. 30 is a flow diagram for a bonus game arrangement that simulates an out of revenue tournament in an in-revenue community bonus event.

FIG. 31 is a flow diagram for a mystery jackpot bonus game.

### DESCRIPTION OF REPRESENTATIVE EMBODIMENTS

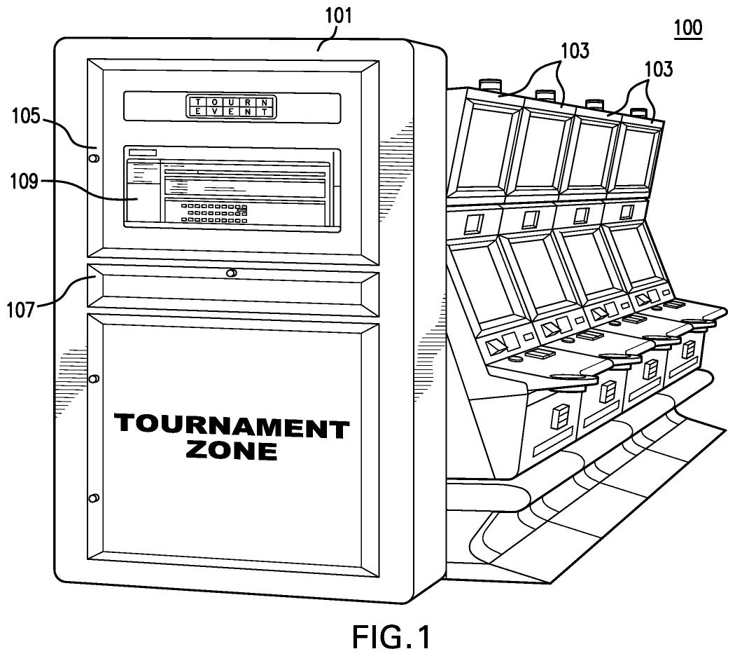

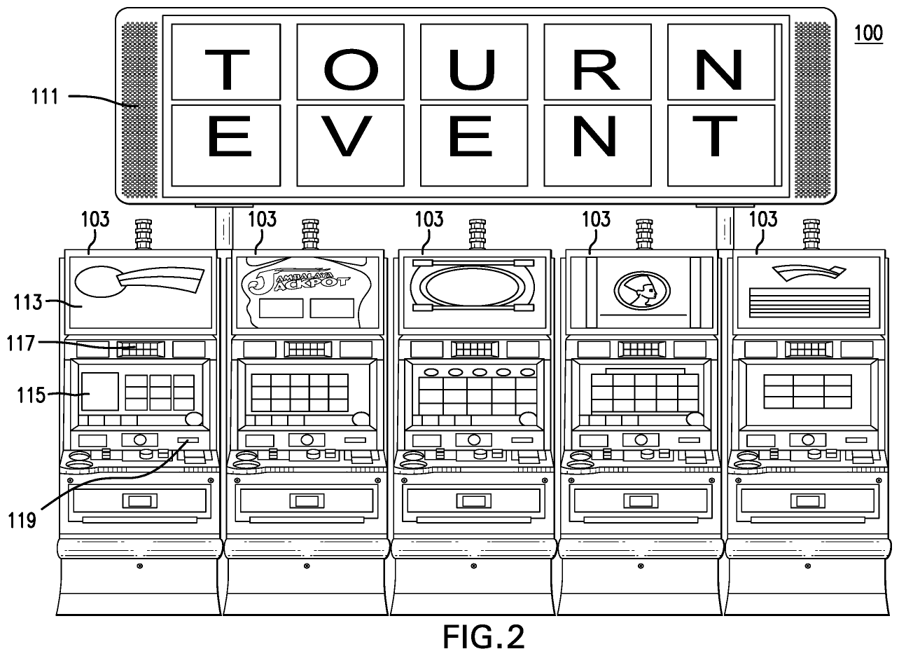

Referring to FIG. 1 and also to FIGS. 2-6, example server-based convertible in-revenue and out-of-revenue gaming system 100 is shown with control center server 101 enabling remote functionality management of a number of gaming machines 103, such as updating game configuration, uploading advertisements, administering tournaments, and converting in-revenue and out-of-revenue operation, in accordance with one or more embodiments. Control center server 101 includes a user console secured by key-locked cabinet doors 105 and 107. The user console includes display 109 and a conventional keyboard and mouse (not shown). Display 109 is visible through a window of door 105. Door 107 opens about a horizontally disposed hinge or hinges situated at the lower portion of the door so that it may swing downward. Behind door 107 a recessed slide-able tray may support the keyboard and mouse and slide outward approximately six to eight inches to accommodate user (such as a casino operator) access to the keyboard and mouse. The keyboard, mouse, and display 109 connect to the server which may be a conventional personal computer motherboard or server grade hardware with ports to support the peripherals along with network connections and memory, such as a hard drive, PROM or CD ROM, containing the programming to support the server controlling in-revenue and out-of-revenue operating modes of gaming machines 103 and to support creation, editing, and storing of command, instruction, and data sets associated with in-revenue and/or out-of-revenue events. The installed software may include a Microsoft Windows® OS enabling menu driven document creation and editing to provide user-friendly document/program search or creation, editing, storage, and execution functionality within the limits of the user's authorization level. User authorization and access may be accommodated through an initial username and password entry screen. Once a user's authorization has been verified through matching with records stored on the server or network, a main menu may be displayed enabling a user to access, initiate or program out-of-revenue or in-revenue events.

As will be discussed further below, control center server 101 may be programmed to implement several different controllers providing functions or services for the gaming machines 103 and associated equipment (such as the overhead display 111 described below). In particular, control center server 101 may implement a tournament controller for controlling and facilitating the conversion of gaming machines 103 from individual in-revenue play to tournament play (either in-revenue or out-of-revenue) and back. During tournament play, the tournament controller communicates with the various gaming machines 103 participating in the tournament, maintains information on the conduct of the tournament, such as real-time standings and scores, and makes tournament information available to the gaming machines 103 or other system elements for display over the course of the tournament. In its operation as a tournament controller, control center server 101 also controls the conversion of gaming machines 103 back from tournament play mode to individual play mode.

During in-revenue operational mode (such as shown for example in FIGS. 1-3), gaming machine 103 may operate conventionally wherein a player may: a) enter currency, such as through bill acceptor 403, b) initiate a wager by selecting one or more lines and one or more credits per line, such as by respectively pressing the lines and credits buttons on button deck 405, and c) initiate play of the game displayed on display 115 by pressing the play, repeat bet, or max bet button on button deck 405. In-revenue operation may be performed through Class II or Class III gaming machines.

Class II gaming machines include bingo-based, lottery and/or central determination gaming machines; for example, a player may initiated a game at a Class II gaming machine, a processor for the gaming machine may send a request for a game outcome which may be transmitted to the gaming machine from an external server (e.g. central determination server) based on a random determination, and a game presentation may be displayed by the gaming machine in accordance with the game outcome. Often Class II gaming systems include a network of connected gaming machines (player stations) and use a finite pool of outcomes wherein the pool of possible outcomes are reduced by one each time an outcome is selected from the pool.

Class III gaming machines may include a random or pseudo-random number generator operated by a processor which may be local or remote to the gaming machine. The processor may determine a game outcome using the random number generator and the gaming machine may display a game presentation in accordance with the determined game outcome.

In either Class II or III gaming machines or systems, the player may be paid an award by the gaming machine or gaming system in accordance with the determined game outcome and a paytable which may be stored on the gaming machine or may be accessible by the gaming machine.

Conversion of a selected set of gaming machines 103 connected to control center server 101 may be programmed to occur at one or more selected times during any period of time, e.g. a day, week, month, as may be elected by a user (operator). In accordance with programming as tournament controller, control center server 101 may transmit instructions to the selected set of gaming machines 103 concerning an impending conversion and subsequently to initiate a conversion from in-revenue operating mode for individual play to a competition operating mode for group play. The programming may be initiated automatically according to a schedule or may be initiated manually by a user. In one or more embodiments, control center server 101 may be programmed to transmit an impending conversion instruction or instructions to the selected set of gaming machines a selected period of time or times prior to the conversion, such as 15, 10, 5, and/or 1 minute. For example, control center server 101 may instruct each gaming machine 103 to display a fifteen minute warning, ten minute warning, five minute warning, and then display a sixty second countdown. Control center server 101 may further instruct each gaming machine 103 to disable additional in-revenue play following the completion of the countdown and following completion of any current game play to automatically cash out the credit meter of any associated gaming machine 103. Following cash out, control center server 101 functioning as tournament controller may transmit instructions to each of gaming machines 103 to display respectively associated players names and to install the competition game for the group play session being initiated.

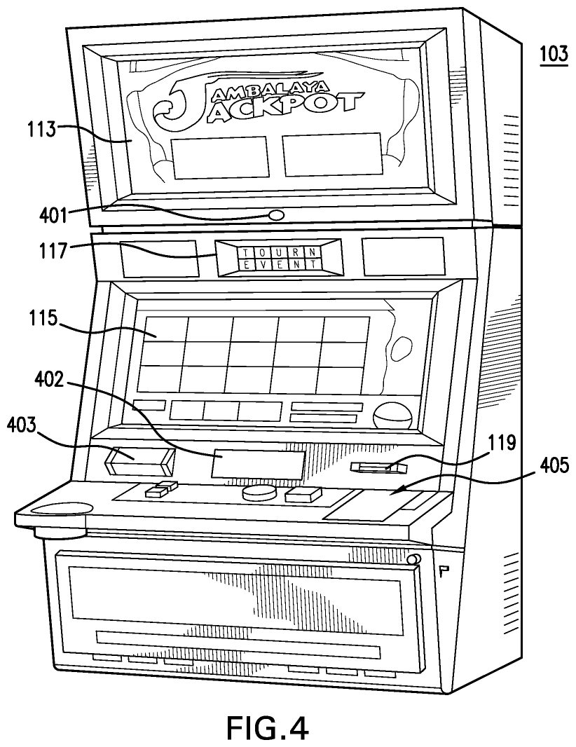

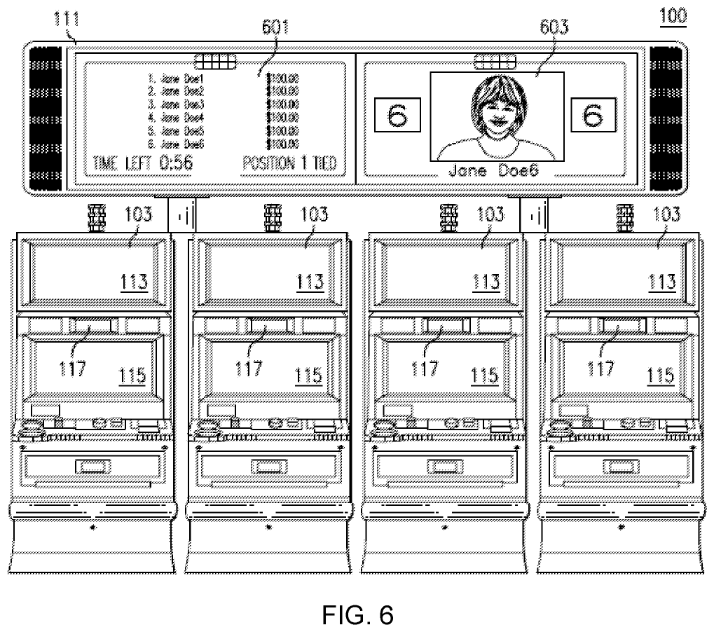

One example of an out-of-revenue operational mode may be a tournament event (such as shown for example in FIG. 6) wherein a game having the same pay table and volatility is installed and operational on each of gaming machines 103. During a tournament event, each participating gaming machine 103 may be operated without funds, players may accumulate virtual points or dollars by playing a game on their respective gaming machine 103, and one or more winners may be identified based on the accumulated totals obtained during a predetermined period of time, which may correspond to a programmed or manually initiated definitive start and stop time or a predetermined number of plays. For example, an operator may initiate a tournament event by using a menu program with the console connected to control center server 101 and selecting: the participating gaming machines, an amount of time for the tournament to play, and begin tournament. Alternatively, the predetermined period of time may comprise randomly triggered start and/or stop times, such as through a game event or through use of a random number generator. During the tournament event, each participating gaming machine may capture live streaming video of tournament contestants through respective cameras 401 (shown in FIG. 4) and transfer the live video feed in accordance with programming to selected locations, such as overhead display 111 (FIG. 6 and others) or player dashboard which may be included display 115 of a gaming machine 103 operating in tournament mode. Throughout the tournament event, leader board 601 shown in FIG. 6 may be displayed on a real-time basis to present tournament standings and live video feed 603 may be displayed to present player reactions on overhead display 111. During tournaments, the player's video may be displayed for a certain amount of time along with their current position. The video feed may then be switched so that overhead display 111 shows live video of another player participating in the tournament. In one implementation, video of all players in the tournament, or some subset such as the top five players, may be serially displayed on overhead display 111. That is, video of the first place player is displayed for a time, then switched to the second place player, then the third place player and so forth, returning to video of the first place player upon completion of showing all or the designated subset of players. Also, some implementations may cause the video displayed at overhead display 111 to be switched when there is a change in rankings of the players in a tournament. For example, the video displayed at overhead display 111 may be switched to live video of the new first place player when a lower ranking player overtakes the leader to become the new first place player. At the completion of a tournament the winner's video may be shown on overhead signs with a celebratory message. In one or more instances, a player may opt for anonymity while playing. In one or embodiments, the player may select a player avatar from a set of available avatars and/or a pseudonym which may be displayed in place of a live video feed of the player.

Referring to FIG. 2, another embodiment of convertible in-revenue and out-of-revenue gaming system 100 is shown with a bank of gaming machines 103 with respective game themes, such as during an in-revenue gaming operating mode, and connected to overhead display 111 (showing an example tournament advertising banner) in accordance with one or more embodiments. Each of gaming machines 103 and overhead display 111 may be conventionally networked to coordinate gaming events and conversion between in-revenue and out-of-revenue operating modes. A networked conversion and controller unit may be an external server, such as control center server 101, a remote floor server, or a remote backend server, or, one of gaming machines 103 may be programmed to operate as a control center server. As shown by example in FIG. 2, gaming machines 103 may be configured in-revenue and have various games being presented or offered, such as Multimedia Games' Ringy Dingy Reels®, Jambalaya Jackpot®, Meltdown®, Queen of the Desert®, and Texas Tornado®, with respective pay tables and volatilities.

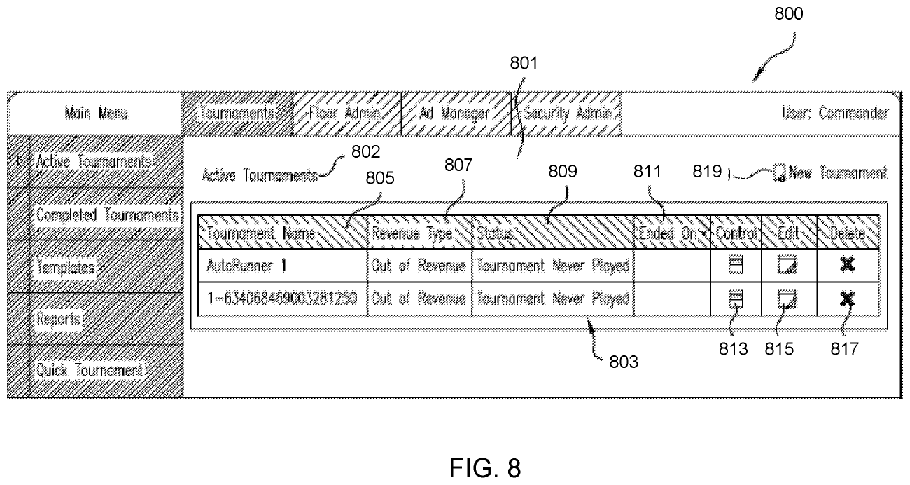

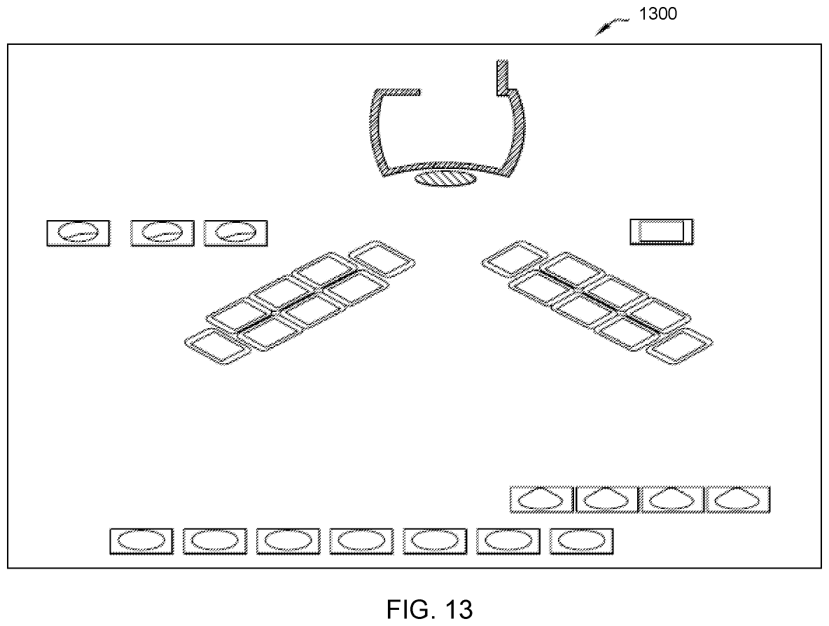

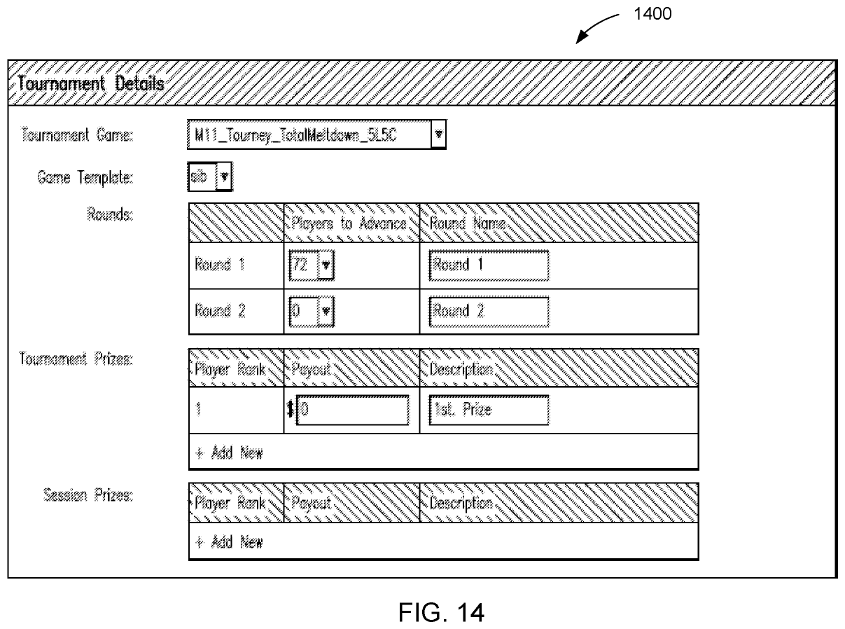

In the case where one of gaming machines 103 may operate as the control center server, the screenshot examples shown herein (e.g. FIGS. 8-17) may be displayed on one of the displays, such as display 113 or 115, each of which or either may be implemented as touch screen displays. In order to access the control center server operability, a user (operator) may be required to insert an authorized user card in card reader 119 and enter a password such as may be prompted on display 117. Upon identification of an authorized user, gaming machine 103 may display a menu on display 113 providing options for initiating or programming in-revenue or out-of-revenue operating modes and may further display a virtual keyboard on display 115 which may be used to enter data into respective fields shown on display 113. Additionally, in the case where one of gaming machines 103 may operate as the convertible server, all or a portion of gaming machines 103 may store the applicable programming so that in the event that an initially designated master gaming machine becomes inoperable, one of the other gaming machines 103 may, either automatically according to a designated priority or manually, be designated to assume the control center server operations.

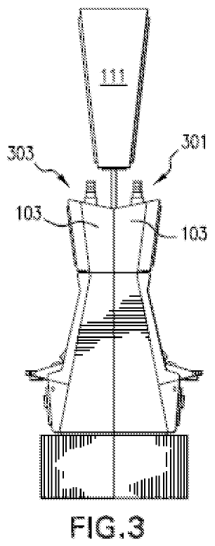

The example implementation of convertible in-revenue and out-of-revenue gaming system 100 shown in FIGS. 2 and 4 may be arranged as shown in FIG. 3 with two back-to-back sets 301 and 303 of gaming machines 103 (which may be referred to as a bank or a pair of banks) with respective game themes, such as during an in-revenue gaming operating mode, and connected to a pair of back-to-back overhead displays 111 (showing an example game theme advertising banner) in accordance with one or more embodiments. Pairs of back-to-back overhead displays 111 may be installed as a single unit on the bank of gaming machines with a casing that may be wider at the top than the bottom and the overhead displays may be slanted to adjust the viewing angle. While the overhead displays 111 may be fixed in relation to the casing, another embodiment may include a swivel attachment of each of display 111 along a horizontal axis enabling adjustment of the viewing angle of each display 111 with relation to the swivel attached to the respective display and the casing. For example the swivel attachments may be secured to the bottom of the casing and the respective overhead display 111; and, tightening screws may be implemented either together with the swivel attachments or separately to fix the angle of the plane of each overhead display 111.

Referring to FIG. 4, an example front view of convertible gaming machine 103 is shown with embedded camera 401, e.g. a conventional IP-video camera, operable to capture video feed of a player at the gaming machine and transfer the video feed to an area of one of gaming machine displays, such as display 113, 115, or 117, one or more other gaming machines' displays and/or overhead display 111. In the example, display 117 is shown with an example tournament advertising banner in accordance with one or more embodiments.

Referring still to FIG. 4, example gaming machine 103 is shown including top glass display 113, middle display 117, primary display 115, and lower display 402 and user interface 405 (including button deck, printer 403, and card reader 119) wherein an in-revenue or out-of-revenue wagering game may be initiated by a player (such as by pressing the ‘Play’ button or by making a wager (selecting a number of lines and credits/line) and pressing the ‘Play’ button), a game processor may obtain a random or pseudo-random game outcome (such as by operating a random number generator (RNG) or by requesting a game outcome from server, e.g. central determination or game, which may use an RNG to make a determination and forward to the game processor). The game processor for gaming machine 103 may instruct one or more displays to display a game presentation (such as spinning the reels in a reel-based game) in accordance with the game outcome, and the processor may pay winning game outcomes by incrementing the credit meter in accordance with the paytable (plus increment any additional amounts in the event of triggering a mystery bonus or other feature bonus).

Top glass display 113 may comprise a programmable portion of or a separate display (such as an LCD, LED, TFT, etc. display) or glass painted, etched, etc. presenting information related to the primary game or theme, such as a display of the paytable associated with the primary game and indicating the awards payable on the various winning primary game outcomes. Display 117 (such as an LCD, LED, TFT, etc. display) may be used to display alternative games (such as a bingo, lottery, card, mini-reel or other wagering game) or other feeds presented through the network, such as advertisements, where the alternative games may or may not require separate wagers or consideration, such as player points accumulated in a player account by a player.

Primary display 115 may display a primary game, such as the displayed Jambalaya Jackpot® reel game, and further display additional information such as lines wagered upon (“Lines”), bet per line (“Bet per Line”), total bet (“Total Bet”), credits on the gaming machine (“Credits”), and any winnings paid following a game play (which may include primary, feature, and community game play) (“Paid”). Display 402 may comprise a portion of display 115 or a separate display (such as an LCD, LED, TFT, etc. display) and display information, such as the player's status, player points, and/or enrollment in any group play (e.g. tournaments or competitions). User interface 405 generally includes a button deck for entering the selected number of lines the player wishes to wager upon, the number of credits per line plus a side bet, and to initiate play of the primary game. User interface may also include card reader 119 for receiving a player card and transmitting player information over a network, and, may include bill acceptor and printer 403 for receiving currency including tickets and printing tickets when a player desires to cash out from the gaming machine.

Referring to FIG. 4, gaming machine 103, such as a Multimedia Games Jambalaya Jackpot® gaming machine, is shown which may by example be connectable as shown in FIGS. 1-3 and have a set of mechanical or video reels displayed by display 115; video camera 401; player interface 405; and, an internally connected game processor. The gaming machine 103 may further include memory with a set of pre-loaded games (e.g. at least one primary in-revenue game for individual play such as the Jambalaya Jackpot® game and at least one group play game such as a tournament or competition game, and perhaps one or more interactive or non-interactive bonus games such as those described in U.S. Pat. No. 9,443,394, incorporated herein) comprising program coding executable by the game processor. The game process may be mounted on a printed circuit board with ports connecting to various sub-assemblies housed in or about the gaming machine cabinet in accordance with one or more embodiments of the invention. While gaming machine 103 is shown as an upright gaming machine cabinet style, various cabinet styles may be utilized including a slant top cabinet style and a bar top cabinet style (where the cabinet may be part of a bar/table top and/or housed therein).

Each reel displayed by or through display 115 includes a series of symbols visible in a display area; for example, in the case of mechanical reels, a portion of each reel is visible in a display area through a window or panel. With the reels in a stationary position, the symbols visible in the display may be viewed as an array of symbols. During a wagering game, such as may be initiated by a player, the reels may be spun about an axle or simulated to spin under the control of a game processor which may randomly or pseudo-randomly determine the game outcome (or obtain the game outcome from a central determination or game server) and cause the reels to stop in accordance with the determined game outcome. Alternatively, the game processor may cause the reels to stop at random or pseudo-random stop positions and then analyze the displayed symbols to identify the outcome for the play.

One or more paylines, combinations, or patterns of the symbols including those visible through the display area may be correlated to a game result payable in accordance with a paytable, such as may be displayed on display 113. The reel display area may thereby be used to display the game result to one or more patrons standing in front of gaming machine 103. While example gaming machine 103 includes a set of five reels, various numbers of reels may be selected or utilized in an implementation of one or more embodiments, such as one, two, three, four, five, six, seven reels, and so forth. In fact, the wagering game may not include reels, and may alternatively display, for example, a video card game (e.g. poker, blackjack), bingo, keno, or roulette. Panel dividers or frames may be painted, etched, virtualized, etc. onto the display area to provide a separate viewable area or window for each reel. The windows may serve to focus attention to the visible portion of the reels and, in the case of mechanical reels, to overlay reel dividers and/or the space between reels.

Alternatively to painting, etching, etc. onto the display area of the window or panel, display 115 may include a panel, such as a flat panel LCD or LED display, which may overlay the display area and be programmed to display an opaque frame image except over the display area (which may be transparent or translucent) during an operating mode when either the primary or group play game are operational, depending upon the selected design. In such case, the panel may be instructed by the game processor to display a bonus or feature game that may be triggered randomly or pseudo-randomly through a RNG, by a threshold count, by a countdown, or by the appearance of one or more special symbols (any of which may be triggers operable through programming executed by the game processor or a network-connected external server), and, may be programmed to enable player interactivity, such as requiring a player to select a displayed button or press an area of a touch sensitive panel overlaying an item, in order to cause the game to perform additional steps and provide one or more bonus or feature game outcomes and awards to the player.

Additionally, in one or more embodiments, the reels may be implemented using flexible reel strips, such as FOLED (flexible organic LED) reel strips, wherein one or more symbols may be programmed dynamically to vary the symbol and/or its appearance, either within a game or enabling conversion from a first game to a second game (i.e. in-revenue individual game to group play game and vice-a-versa). Additionally one or more display panels may be implemented to present each reel virtually. In the case of virtual displays of the reels, the symbols may be fixed or animated on each of the simulated reels. Also, overlapping display panels may be implemented to generate video or display effects over reels; for example, display 115 may be implemented to include transmissive (e.g. Aruze or WMS transmissive display panels) or transparent (e.g. a Bally® transparent display panels) panels configured to display visual effects together with a set of reels (mechanical or virtual) under the control of the game processor during the operation of an in-revenue or out-of-revenue wagering game. In the case of virtual reels, the virtual reels may be recessed a distance from the front surface of the display area and segregated by dividers similar to dividers separating mechanical reels, which may provide a spatial characteristic (e.g. a PureDepth® display panel).

In one or more embodiments, the game processor operating the wagering game and controlling game lighting and effects in many instances is implemented as a microprocessor, such as an Intel Pentium® or Core® microprocessor, on a printed circuit board including one or more memory devices positioned within gaming machine 103. In alternative implementations, the game processor may be remote from gaming machine 103, such as on a server network connected to gaming machine 103 (e.g. gaming network 100, FIG. 1 or 1800, FIG. 18), in which case the game operation as described herein may be accomplished through network communications to control the display of the game on gaming machine 103 including the audio, visual, and game effects. It should be noted here that any terms indicating relative position used in this disclosure and the accompanying claims such as “front,” “rear,” “lateral,” “back,” and “top,” for example, are used with reference to the operating position of gaming machine 103 shown in FIG. 4.

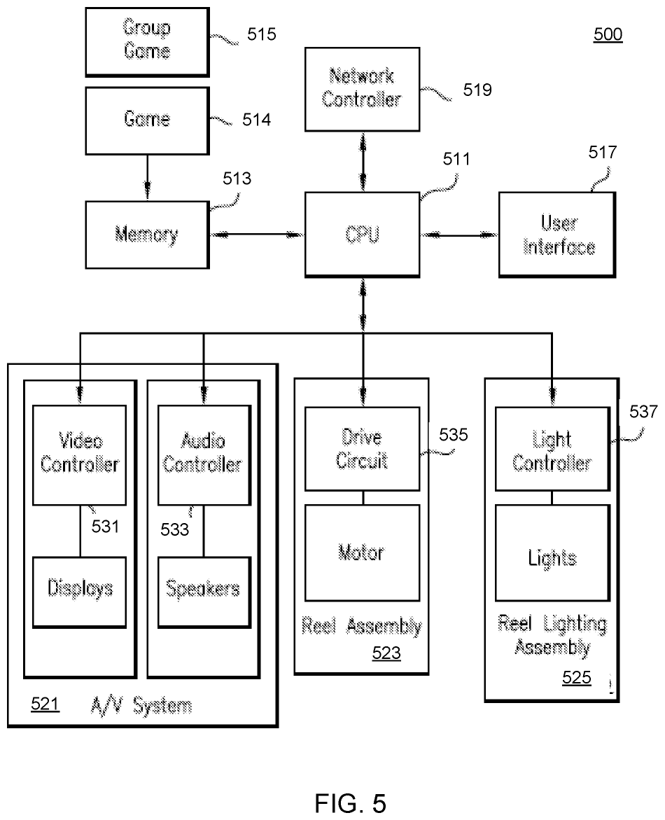

Referring to FIG. 5, an example control structure 500 of gaming machine 103 is shown in accordance with one or more embodiments of the present invention. Game processor (CPU) 511 may comprise a conventional microprocessor, such as an Intel Pentium® or Core® microprocessor, mounted on a printed circuit board with supporting ports, drivers, memory, and coding to communicate with and control gaming machine operations, such as through the execution of coding stored in memory 513 including one or more individual wagering games 514 and one or more group play games (e.g. tournaments, competitions) 515. Game processor 511 connects to user interface 517 such that a player may enter input information and game processor 511 may respond according to its programming, such as to apply a wager and initiate execution of a game. Game processor 511 also may connect to a network, such as casino server network 1800 (FIG. 18) which may be implemented over one or more site locations) which may include host, remote game play, central determination, progressive, player tracking, and accounting server functionality (see generally, FIG. 18), through network controller 519 to enable network monitoring and sharing of data and information between respective of the servers in the network and gaming machine 103. Game processor 511 may also connect to various devices within and about the gaming machine including A/V system 521, reel assembly 523, and reel lighting assembly 525 through respective controllers, such as one or more video controllers 531, audio controllers 533, motor drive circuit controller 535, and light controller 537. In the case where the reels are implemented using a video display, reel assembly 523 and reel lighting assembly 525 may be modified or eliminated depending upon the desired configuration; for example, in one or more embodiments, it may be desirable to use reel lighting assembly 525 to amplify or provide various light effects in conjunction with a video reel display during game play, alternatively this functionality may be absorbed into the video display coding and presentation.

Generally, activity at gaming machine 103 may be initiated by a player inserting currency and/or a player card into a bill acceptor and card reader, respectively. Upon insertion, a signal is sent to game processor 511. In the case of the insertion of a player card, the card reader transmits card information which is directed through network controller 517 to a player tracking server connected to the network. Player data is transmitted to gaming machine 103, and, responsive to the data, game processor 511 may execute coding causing player data and a display (and possibly an audio) command to be transmitted to one of the video and/or audio controllers instructing the controllers to display player information on a respective display and possibly issue an audio greeting through one or more respective speakers. Concurrently, the bill acceptor sends a signal to game processor 511 which may include an identification of the currency that has been read, and game processor 511 in accordance with its coding may convert the currency amount to credits and transmit a store and display signal to a credit meter and its associated display (“Credits”). Once credits have been associated with the credit meter, the player may (for a reel-type game) select the number of paylines and credits per line that the player wishes to wager, whereupon game processor 511, in accordance with its coding, receives the wager information from user interface 517, transmits accounting and display information to the payline (“Lines”), credits per payline (“Bet per Line”), and total bet (“Total Bet”) meters and displays, transmits an update to the credit meter and display (“Credits”) deducting the amount of the total bet, and initiates the wagering game.

In the case of Class III gaming devices, when a game is initiated, a random number generator (RNG) is operated by game processor 511 to determine the game outcome. Commonly, game processor 511 is positioned within gaming machine 103 and configured to manage the operation of the gaming machine components, such as shown in FIG. 5; however, the game processor may be either onboard or external to a gaming device (such as an electronic tablet (e.g. Apple iPad or gaming specific tablet), personal data assistant (PDA), cellular telephone (e.g. Blackberry or Apple iPhone), surface table (e.g. Microsoft/IGT touch sensitive gaming surface table)) played by a player. Therefore, when the player places a wager and initiates play of the game through user interface 517 of the gaming device, the game processor may be onboard or remotely located such as within a network gaming server. In the latter case, an onboard microprocessor, controller, or digital signal processor may execute coding to transmit the wager and game request information through the network and the remote game processor may operate an RNG to determine the game outcome. In one or more embodiments, coding may be implemented and stored in memory 513, 514, and 515, executable by game processor 511 to control the primary and feature game execution and to control associated electro-mechanical devices, such as reel lighting, speakers, and reels through respective video, audio, reel drive motor controllers, and lighting controllers 531, 533, 535, 537.

Program coding may be stored to execute and/or integrate gaming device operation with a tournament or competition, such as described herein, where a selected gaming machine 103 from a bank may be designated as control center server 101. For example, each gaming machine 103 of a bank may include coding executable by the designated host game processor to initiate and operate a tournament or competition game and also include coding to respond as a client gaming machine on the bank responsive to a primary controller. One of the gaming devices 103 may be designated as the primary controller responsible for converting operating modes of the selected banks of gaming machines 103, operating tournaments or competitions, and controlling content display on one or more displays, such as overhead display 111 and/or respective displays 113. In the case that the primary controller becomes unavailable, a second gaming machine may be designated as the backup primary controller and a rule of succession may be coded into each of gaming machines 103 of a respective bank. Each of the gaming devices may include monitoring coding executable on an ongoing periodic basis to ascertain which gaming device is the active primary controller during a given time period. Alternatively, the primary controller may be responsible to execute periodic polling of each of gaming machines 103 of the respective bank; and, in the event that the backup primary controller does not receive a poll within a designated period, the backup primary controller may commence operation as primary controller, commence polling operations, and commence execution of coding to randomly determine when to initiate the associated tournament game.

In one or more alternate embodiments, gaming machine 103 may have multiple games pre-loaded including a primary game (generally operational for in-revenue individual play) and a group play (tournament or competition) game, wherein either game may be operable by the game processor (depending on the setting or operating mode as may be controlled by control center server 101 through network commands) by executing respective of the game codes stored in memory. By example, the primary game may initially be operable for in-revenue individual play; the group play game may be initiated by a command from control center server 101 whereby gaming machine 103 may be converted from in-revenue individual play to group play (which may be in-revenue or out-of-revenue depending on the game rules and associated programming).

Once initiated, the group play game may be displayed on one of the displays operable by gaming machine 103, such as display 113 or 115 (reel display area), where a video representation of the group play game may be presented by either replacing or overlaying primary game display content. For example, if display 115 includes mechanical reels, display 115 may also include an overlaying panel (such as a flat panel display) which may be changed from a transparent mode during primary (or alternatively, group play) game operation to an opaque mode during group play (or alternatively, primary) game operation by instructions from the game processor instructing display 115 to mask the mechanical reels and display a video game associated with the group play (such as a reel-based game, video card game (e.g. poker or blackjack), bingo, keno, roulette or other wagering-type game). In the case where display 115 comprises two or more displays with or without mechanical reels, one or both displays may be used separately or together to display video content for the primary game and the group play game (for example, special effects or symbols may be rendered through an overlaying display while the underlying display displays the reels of the primary game or the field (or surface) of the group play game, depending upon which game is being shown or played).

Referring to FIG. 4, camera 401 may be activated to capture real-time images of the player at the gaming machine and these images may be transmitted directly (or indirectly through an intermediate processing device) to one or more displays in accordance with programming executed by the game processor and requests by control center server 101 (or another gaming machine 103 or remote device operating as the control center server).

Referring to FIG. 6, an example embodiment of convertible in-revenue and out-of-revenue game system 100 is shown with a bank of gaming machines 103 in a tournament mode (which may be operable either in out-of-revenue or in-revenue modes) and with overhead display 111 showing an example real-time leader board 601 and player video feed 603 in accordance with one or more embodiments wherein players at each of the gaming machines 103 compete by playing their respective gaming machine 103 and accumulating a total award based on their play. In the example, each of gaming machines 103 are operating the same game as shown on display 115 and leader board 601 is displayed on display 113 as well as on overhead display 111. Overhead display 111 also displays player video feed 603 which includes the image of one of the players; in the example shown, the video image displays the player, the player's name, and the player's position in the competition (6th place as reflected by the ‘6’ displayed adjacent the player's image). Leader board 601 includes the first six player's position, name, and accumulated point total. Leader board 601 may be updated in real-time to show current positions and accumulated totals of the respective players. Additionally shown with leader board 601 is a ‘Time Left” countdown. Leader board 601 may also sequentially display standings of each of the players, such as by cycling through all the player positions from first through the total number of participating players. On each of gaming machines 103, display 115 may be personalized to show the top player's positions while also showing the name of the player playing the respective gaming machine displayed as a header and the player's name, position and accumulated points highlighted on the leader board. In the example, the name of the respective player, position, and points may be circled on the respective display 113 so that the player at that gaming machine 103 may readily identify their ranking. In the case where the respective player is not in the top five, then the player's name, position, and accumulated points may be appended to the bottom of the displayed leader board on display 113 of that player's gaming machine 103.

In one or more embodiments, video feed may be delivered to each of displays 113 (or perhaps a window in display 115) during an event to show video feeds of each of the participating players, such as by cycling every five seconds to rotate real-time or quasi-real-time images of the players, and/or to show a video feed of the respective player during the course of the event.

In one or more embodiments, the player video feeds and the leader board may be broadcast to wireless devices, such as cellular phones. For example, a gaming facility or operator may maintain a website server and website, enabling individuals to dial- or log-in to the website to receive audio-visual broadcasts of events occurring within the facility. The website server may receive updates through the network of various events that may be occurring simultaneously and update web pages associated with the website, enabling visitors to the website to view streaming and fixed content. The website may be maintained through a controlled-access intranet or broadly accessible internet service. In the case of controlled-access, each patron of a gaming facility may be provided a temporary username and password, such as may be provided during a patron's stay at a resort associated with the gaming facility. Patrons may thereby use their remote wireless device to enroll in a gaming event and pay an entry fee, monitor their time to attend the gaming event, and monitor their position within a gaming event in the case where there are more than one session or round associated with the gaming event.

Additionally, players enrolled in events may receive notifications, such as an automated phone call or text message, to advise the player of the time to attend the event, to advise the player of a player's position change within the event, or to advise the player of a delay in the event. Players may, for example, request notification at the time of enrollment or thereafter by using an identifying process, such as entering a username and password, to connect to a server and database with event and player information. Such notifications may also occur through a display and/or speaker at a gaming machine 103 being operated by a player. For example, if the player has requested a notification concerning an event and the player has a player card inserted in a gaming machine. The event server or the website server may query the player tracking server if the player's card is identified connected to a gaming machine 103, identify the gaming machine 103, and transmit an instruction to the gaming machine 103 to display the notification on one of the associated displays. In another alternative, player cards with embedded identifiers (and enrolled cellular phones) may be identified through positioning systems within a gaming facility, such as GPS or related systems or proximity detection systems. Once an enrolled player is detected, a notification may be transmitted to a nearby display and/or speaker.

Similar features may be provided through an internet portal enabling visitors or patrons to access a website and similar restrictions may be implemented, if desired. For example, different levels of access may be provided to general visitors to the site versus current or past patrons to the gaming facility and/or associated resort.

In an alternate embodiment, patrons or visitors may dial-in to an audio-visual broadcast that may be accessed through their respective wireless or network connected devices, such as cellular phones or personal computing devices (e.g. personal computers, electronic pads, personal organizers, etc.). The content may be provided similar to a television broadcast wherein a schedule of events may be provided along with broadcast times. The broadcast network may be implemented as a closed circuit broadcast providing restricted access or may be implemented as an open broadcast.

At the completion of the tournament event, a celebratory event may be displayed on overhead display 111 to name the winner and present fanfare. The celebratory event may be displayed on one or more of displays 113, for example at the winner's gaming machine 103. In one or more embodiments, the streaming videos of the event may be recorded along with the leader board updates for the duration of the event, such that each of the participating players may be provided a personalized copy of the event, such as a DVD. In other alternatives, the event may be re-broadcast or accessible on-demand, such as through the gaming facility's website as described above.

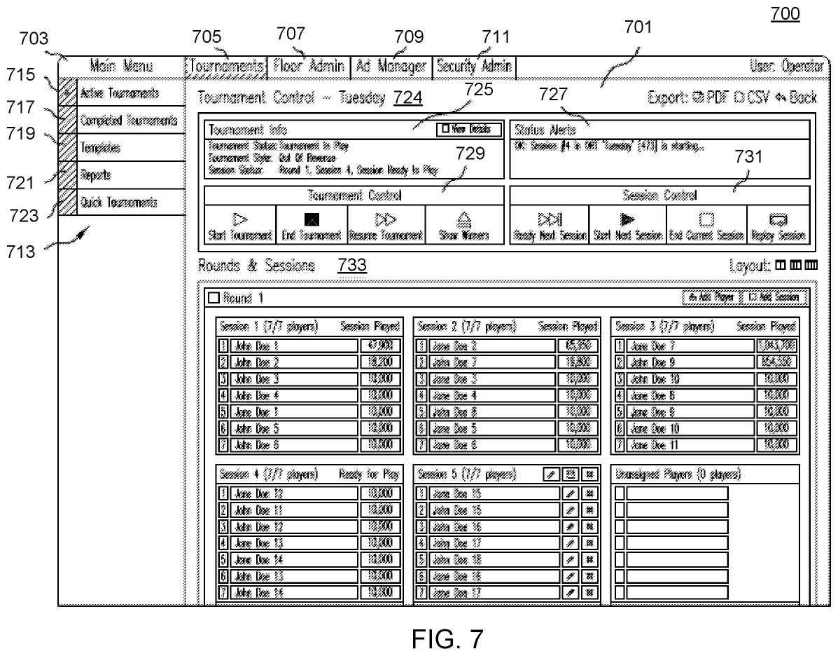

Referring to FIG. 7, screenshot 700 of active tournaments control page 701 is shown which may, for example, be displayed at a user interface console of control center server 101 controlling one or more banks of gaming machines 103 in accordance with one or more embodiments. In the example, several drop-down menus and associated pages may be viewable to an operator on display 109 (FIG. 1) and accessible either through a touch screen, keyboard, mouse, or combinations thereof. The menus may include main menu 703, tournaments 705, floor admin 707, ad manager 709, and security admin 711. In the example screenshot, tournaments menu 705 has been selected and is highlighted and drop-down tournament sub-menu 713 is displayed. As shown, tournament sub-menu 713 may include a selection of available pages accessible through icons including active tournaments icon 715, completed tournaments icon 717, templates icon 719, reports icon 721, and quick tournament icon 723. In the example, active tournament icon 715 has been selected as indicated by an arrow to the left of the icon and corresponding active tournaments control page 701 is displayed.

With reference to active tournaments control page 701, various fields are visible including: Tournament Control Header field 724, Tournament Info field 725, Status Alerts field 727, Tournament Control field 729, Session Control field 731, Rounds & Sessions field 733. Tournament Control Header field 724 includes the currently active tournament title, which in the example is the ‘Tuesday’ tournament. Tournament Info field 725 may display Tournament Status, Tournament Style, and Session Status headers and corresponding data or information accessed from memory (which may be automated to update periodically or in real-time through the server processor). For example, Tournament Status shows the currently programmed tournament is in play mode, Tournament Style shows that the current tournament is an out-of-revenue event, and Sessions Status shows that Round 1, Session 4 is ready to be played. Tournament Info field 725 also may include a selectable View Details icon which when selected causes the details of the Rounds & Sessions to be shown (current view) including the players enrolled for each session of the current round. Status Alerts field 727 displays the active tournament status, and in the example shows that the tournament is operating normally (OK) and that Session #4 for the Tuesday out-of-revenue tournament (ORT) is beginning play. Additionally, Status Alerts field 727 may display problems with any gaming machines 103 transitioning from in-revenue to out-of-revenue and vice-versa.

Tournament Control field 729 shows selectable control icons which may include Start Tournament, End Tournament, Resume Tournament, and Show Winners icons; in the example, only the End Tournament icon is active and selectable since the current tournament is in progress. In the event that the End Tournament icon is selected, the tournament would be stopped, the End Tournament icon would become inactive and the Start Tournament, Resume Tournament, and Show Winners icons would become active. If the Start Tournament icon was then selected, the current results of each session would be removed, and the tournament would begin play of Session 1. If, instead, the Resume Tournament icon were selected, the tournament would retain the results of the completed sessions and begin play of Session 4 which was the session that was indicated as beginning play in the Status Alerts field. Alternatively, if the Show Winners icon were selected, then the results of the completed sessions would be used to determine the winners and the winners would be displayed, such as on overhead display 111 and/or displays 113, along with any celebratory presentations.

Session Control field 731 shows selectable control icons which may include Ready Next Session, Start Next Session, End Current Session, and Replay Session icons; in the example, only the Start Next Session icon is active and selectable since Session 4 is ready to begin play. After the Start Next Session icon is selected, the End Current Session would become active. After the Current Session ends, then the Ready Next Session and Replay Session icons may become active to give an operator an option to replay the previous session, for example if one of the gaming machines 103 went down during play, or have the system prepare the next session for play.

Referring to Rounds & Sessions field 733, each of the sessions of a round may be displayed including the players' names. In the example, Round 1 has five sessions, and each session has seven players. Sessions may be added by selecting the Add Session icon and players may be added by selecting the Add Player icon. Additionally, the number of player slots (or gaming machines 103) per session may be specified, such as by selecting/de-selecting a bank from the floor or selecting/de-selecting gaming machines from a live floor display available through control center server 101. For example, a user may initially select eight gaming machines per session and populate the players that have signed up (for example, twenty-four players) into three sessions; then the user may de-select two gaming machines, so that six gaming machines may be used per session, then the programming may re-populate the players into four sessions. In the event that a player session board is displayed, each of the player sessions may be displayed with the players in their respective sessions. Additionally, tentative times for the beginning of each session may be displayed, enabling the players to view the sessions and the session times to plan their time. In other alternative embodiments, the convertible system may transmit the session information through a transmitter, such that players may receive their respective session assignments and session times through receivers, such as cell phones, receiving SMS or voicemail, or, through a display at a gaming machine (in which case the transmission may be sent through a player tracking server or by using information provided by a player tracking server).

An option may be incorporated in Rounds & Sessions field 733, wherein each of the sessions may be color-coded through programming to enable a user to easily identify sessions that have been played, are ready to play, and are waiting to play. In the example, the display areas associated with: Sessions 1-3 (played) may be shaded a blue color, Session 4 (ready for play) may be shaded yellow, and Session 5 (waiting to play) may be shaded green.

In the example, Sessions 1-3 of Round 1 have been played and may be color-coded blue, while Session 4 is ready for play and may be color-coded yellow. In the header of Sessions 1-3, the session number, number of players/number of player stations, and ‘Session Played’ are shown. Below the header, a listing of the players and their final scores are shown for completed sessions only. In the header of Session 4, the number of players and player slots are shown as well as an indication that the session is ready for play. Below the header, each player's name is shown along with an initial (starting) score (e.g. 10,000 points or credits). In the header of Session 5, seven players are shown as signed up for seven slots. Additionally, selectable edit (pencil) and cancel (x) icons are provided enabling an operator to modify or cancel the session. Furthermore, an edit (pencil) and cancel (x) icon are provided beside each player's name enabling an operator to remove a player or replace a player. Additionally, each player in a session that has not yet been played can be dragged (by selecting a player name, dragging the name, and dropping) from one session to another session, or may be unassigned in instances where the player is no longer participating in the session or tournament.

In one or more embodiments the number of gaming machines 103 eligible for play in a tournament may be modified by accessing Floor Admin menu 707. For example, the number of eligible gaming machines 103 may be modified from seven (as shown) to eight. Also, the eligible gaming machines 103 on one or more banks may be individually selected using a selectable graphical interface virtually displaying one or more banks linked to convertible server 101. For example, if there are two banks of six gaming machines 103, the operator may select the inner four gaming machines 103 on each bank to participate in the Tuesday tournament. Once eight gaming machines 103 have been selected by the operator, convertible server may assign a number from one to eight to each gaming machine 103. As shown, Session 1 has gaming machines one through seven; once modified, an eighth gaming machine 103 may be shown available during each session. Prior to the tournament, as each player signs up for the tournament, they may be assigned to a session and a gaming machine. When the session is ready to play, control center server 101 may transmit an instruction to each of the eligible gaming machines with an assigned player and instruct the respective gaming machines to display a respective player's name on display 113. Alternatively, after the tournament has sent a message to the eligible gaming machines to display the assigned player, an additional message may be sent to instruct the gaming machine to change the name of the player based on actions that may be taken by a user such as by modifying the session players on the user display as in FIG. 7 and executing in accordance with the illustrated and described tournament control process and apparatus.

Referring to FIG. 8, screenshot 800 of active tournaments page 801 is shown which may, for example, be displayed at the user interface console of control center server 101 (shown in FIG. 1) following an authorized user successfully logging on. Active tournaments page 801 may display header 802 and tournament list 803 including all tournaments currently active on the system. The list may provide a field for tournament name 805, revenue type 807, status 809, and end time 811. Each listing also includes an associated selectable icon: control 813, edit 815, and delete 817. Additionally, active tournaments page 801 may include new tournament selectable icon 819. Selection of control icon 813 may take the user to the display screenshot shown in FIG. 7, thereby giving the user the ability to manage and control one or more tournaments at a time.

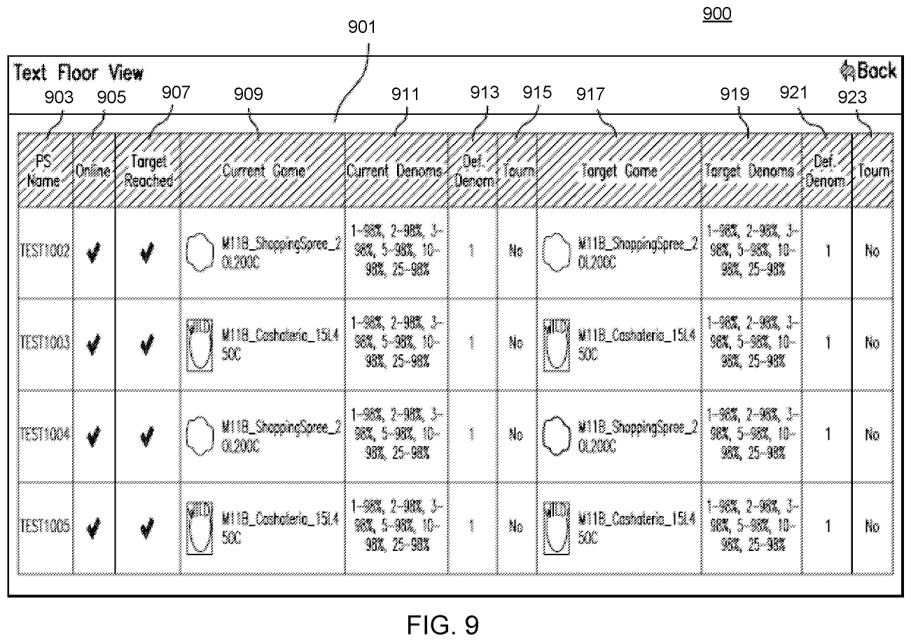

Referring to FIG. 9, floor listing 901 may include headers and associated fields for identified gaming machines (player stations, PS) 103, such as PS Name 903, Online status 905, Target Reached status 907, Current Game 909, Current Denominations 911, Default Denomination 913, Tournament 915, Target Game 917, Target Denominations 919, Target Default Denomination 921, and Target Tournament 923. Target values may refer to user initiated selections and Target Reached 907 may indicate whether the user initiated selections have been implemented on respective of gaming machines 103. For example, the first listing identifies gaming machine 103 as TEST 1002. A green check mark under Online 905 indicates TEST 1002 is online. A green check mark under Target Reached 907 indicates that all player initiated target features (identified changes at the gaming machine) have been achieved (or implemented). The current game being provided by TEST 1002 is identified as M11B_ShoppingSpree_20L200C. Current denominations are indicated as 1, 2, 3, 5, 10, 25 currency denominations and the statistical payout for each denomination is indicated as 98%. The default denomination is indicated as ‘1’. TEST 1002 is identified as not in tournament (for example, out-of-revenue) mode. The target settings correspond to the current settings indicating that all user initiated selections have been implemented on TEST 1002.

An example process for modifying a live floor view may include:

| Task | Procedure |
|---|---|
| enlarge an object on the | 1 Move the cursor to the object. |
| floor view | 2 From the context menu, select Zoom In. |
| shrink an object on the | 1 Move the cursor to the object. |
| floor view | 2 From the context menu, select Zoom Out. |
| restore the live floor view | From the context menu, select Original |
| | View. |
| update the live floor view | From the main menu or context menu, select |
| and display | Refresh Floor. |
| changes that were made | |
| since the last update | |
| move player station | 1 From the main menu, select Edit Floor. |
| symbols | 2 Select the player station symbol. |
| | 3 Choose from the following actions: |
| | Drag the blue circle to move the symbol. |
| | Drag the red circle to pivot the symbol. |
| | Type new coordinates in the Current |
| | Selection boxes. |
| | Click the arrow keys on the menu. |
| | Click the pivot boxes on the menu. |
| | Press the arrow and navigation keys on the |
| | keyboard. |
| | 4 Click Save Changes. |

Following changes, a user may view the status of the floor after the targeted changes are applied by using commands available through the floor view section of the main menu. To cancel a targeted game change, the user may select applicable gaming machine 103 and select the Clear Target option.

An example of steps for managing gaming machines 103 may include:

| Task | Procedure |
|---|---|
| select individual player | Select each player station individually. |
| stations | |
| select all player stations | From the Actions menu, select Select all |
| | player stations. |
| select a player station by | 1 From the Actions menu, select Select |
| name | station by name. |
| | 2 In the user prompt window, type the |
| | player station ID. |
| | 3 Click OK. |
| select a player station by | 1 From the Actions menu, select Select |
| bank name | player station by bank. |
| | 2 In the user prompt window, type the bank |
| | ID. |
| | 3 Click OK. |
| select all player stations in | 1 From the main menu, select Banks. |
| a bank | 2 Click the arrow in the Select player |
| | stations in bank box to display the bank |
| | names. |
| | 3 Select the bank name. |
| unselect individual player | Click each player station again. |
| stations | |
| unselect all player stations | From the Actions menu, select Clear |
| | selections. |

By selecting Banks from the main menu, a user may group gaming machines 103 into a new or saved organizing unit, referred to as a bank, to conveniently modify gaming machines 103 as a group, e.g. set up an out-of-revenue event. Gaming machines 103 may easily be removed from a group, such as by selecting a respective gaming machine in a graphical view and selecting Remove selected PS from bank in the Banks menu.

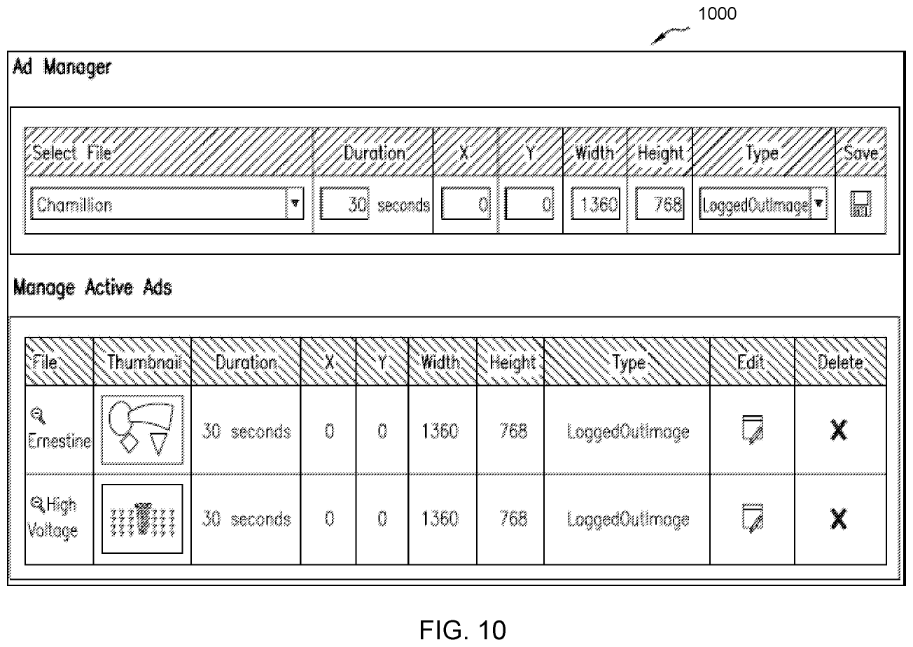

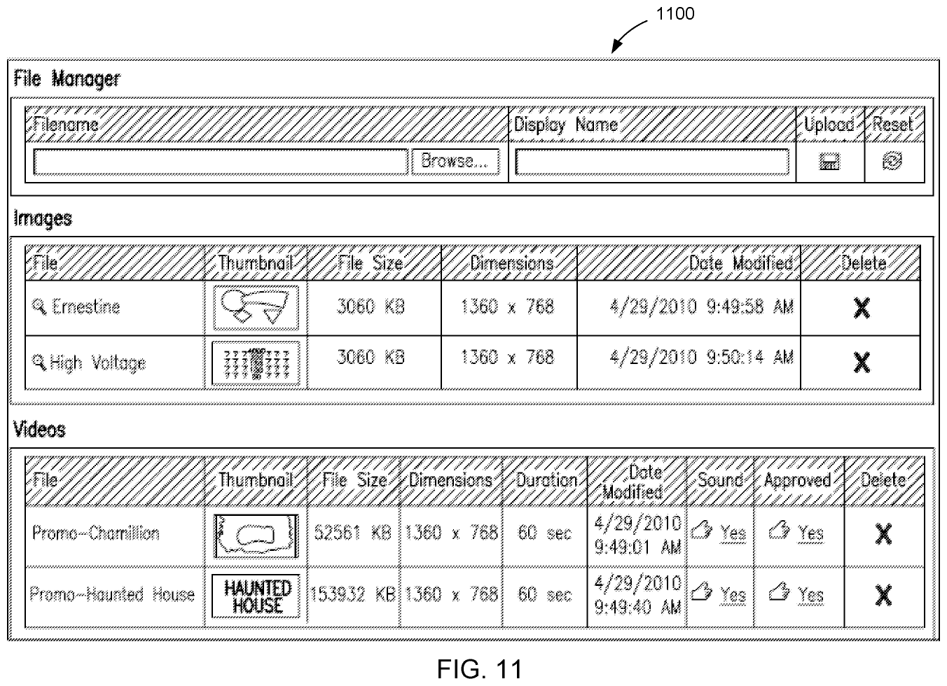

Referring to FIGS. 10 and 11, example advertisement manager and file manager screens 1000, 1100 are shown. By selecting Ad Manager from the main menu, a user may display screen 1000 in order to manage and display ads on one or more selected displays, such as display 111 and displays 113 of an associated bank of gaming machines 103. For example, an ad may be identified by a user from a set of uploaded advertisement files and set for display on overhead display 111 (e.g. FIG. 2). In the event, an advertisement is desired that has not been uploaded, a user may access a file available through a storage location on the network or from an alternate storage location, such as a conventional USB, lockable USB, or CD storage device, by selecting File Manager from the main menu, locating the file, defining a name, and uploading the file for accessing through the Ad Manager menu.

For example, advertisements on networked displays may be managed to add a new advertisement as follows:

1 Click Ad Manager, located at the top of whatever view is current (next to Floor Admin, Reports, Tournaments, and Security Admin icons). The Ad Manager: New Ad page displays.
2 From the menu displayed in the left column, click File Manager. The File Manager is the mechanism to load ads into TournEvent® system from an external source.
3 Click Browse and select the file you wish to upload into TournEvent® system.
4 Click Upload on the right side of the File Manager: Upload File page. File details and the uploaded image display.
5 Repeat steps 3 and 4 until all desired ads have been uploaded into TournEvent® system.
6 Click Manage Ads in the left column of the File Manager display.
7 Click the Select File dropdown in the Ad Manager: New Ad section and select the image to display.
8 Select the duration, and x/y offsets (default=0 is usually OK) and the width/height (usually the same as the monitor resolution). From the Type dropdown, select logged out image. This is so that the ads will not run on the top display when players are logged into the player stations. Once these parameters are defined, click Save.
9 The newly saved ad displays in the Ad Manager: Manage Active Ads portion of the Ad Manager page.
10 Enable the Ad Manager service from the TournEvent® management terminal and the ads will soon start displaying.

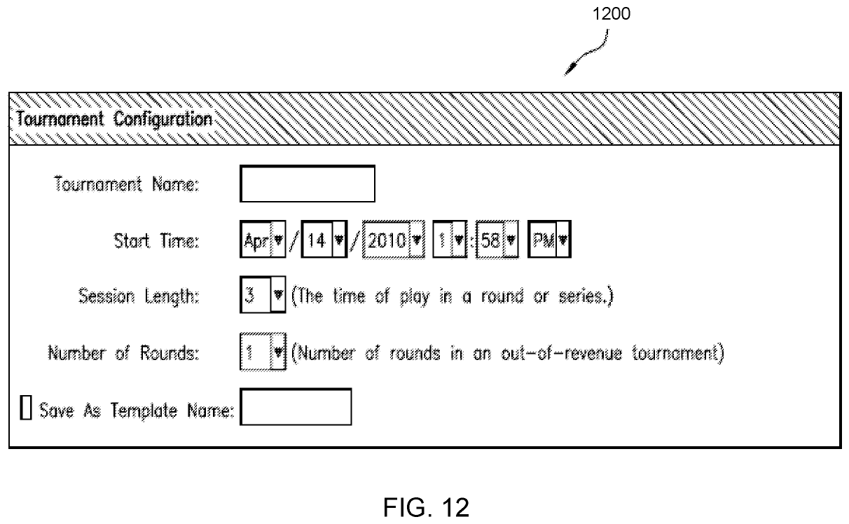

Referring to FIGS. 12-14, tournament configuration, tournament graphical display, and tournament details screens 1200, 1300, and 1400, respectively, are shown that may be accessed by selecting Tournaments from the main menu shown in FIG. 8. For example, a user may create a tournament (or an out-of-revenue event) without a template as follows:
1 From the application bar, select Tournaments.
2 On the Active Tournaments screen, click New Tournament.
3 At the Load from Template prompt, select No.
4 In the Tournament Configuration box, complete the options.
5 In the Tournament Name box, type a unique name to identify the tournament. You can use a maximum of 12 letters, numbers, and spaces.
6 Click the arrows in the Start Time boxes to specify the start date and time.
7 Click the arrow in the Session Length box to select the duration of the tournament in minutes.
8 Click the arrow in the Number of Rounds box to specify more than one round for the tournament.
9 To save these specifications for use with another tournament, complete the following steps:
10 Select Save As Template.
11 In the Name box, type a unique name to identify the template.
12 Add player stations to the tournament by selecting them from the floor map.
13 In the Tournament Details box, select the Tournament Game, then the Game Template.
14 In the Rounds box, complete the options.
If you selected one round in the Tournament Configuration Number of Rounds box, type an optional name for the round in the Round Name column. If you selected more than one round in the Tournament Configuration Number of Rounds box, multiple rounds display in the Tournament Details Rounds box. Click the arrows in the Players to Advance column to select the number of winners from each round to move to the next round. In the Round Name column, type an optional unique name to identify each round.
15 To create additional award levels, in the Tournament Prizes box, click +Add New.
16 In the Payout boxes, type the prize amounts.
17 In the Description boxes, type the award names.
18 Repeat the previous two steps for Session Prizes, if necessary.
19 Click Add Tournament. The Add Player to Tournament window displays.
20 Enter part of a player's name in the Player Name field and click Search, or select a name from the Player Name drop-down menu. Alternately, select from the All Existing Players list. Click Create New Player to add a new player.
21 Click Save Player Selections. The Tournament Control screen displays details about the tournament.
22 Touch Back to return to the Active Tournaments screen.

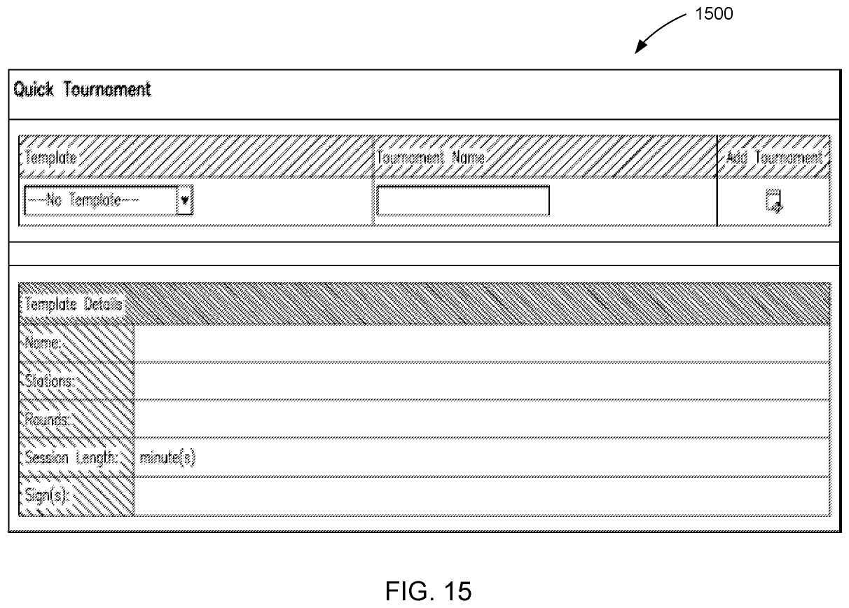

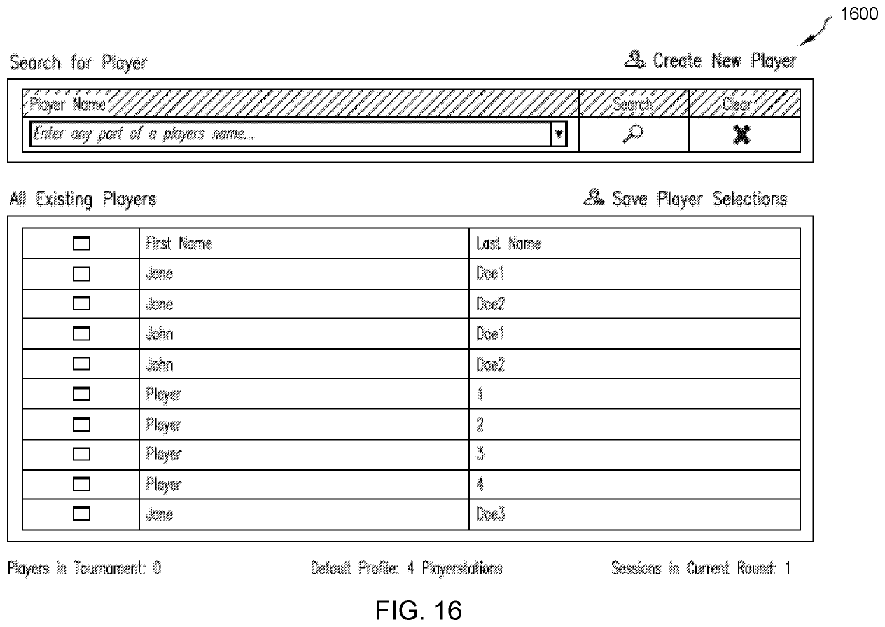

Referring to FIGS. 15-16, quick tournament and search for player screens 1500, 1600 are shown that may be accessed by selecting Tournaments from the main menu shown in FIG. 8. For example, a user may quickly create a tournament (or an out-of-revenue event) without a template as follows:
1 Click Tournaments, then click Quick Tournament. The Quick Tournament screen displays.
2 Select the Template this tournament will be based on, then enter a Tournament Name.
3 Click Add Tournament. The Add Player to Tournament window displays.
4 Add players to the tournament:
Enter part of a player's name in the Player Name field and click Search, or select a name from the Player Name drop-down menu.

Alternately, select from the All Existing Players list.

Click Create New Player to add a new player.
5 Click Save Player Selections. The Tournament Control screen displays.
6 Run the tournament.

Referring again to FIGS. 8 and 16, a user may enroll players and manage gaming machine 103 assignments after creating a tournament specification as follows:
1 From the application bar, select Tournaments.
2 From the list of active tournaments, click beside the appropriate tournament.
3 Click Add Player. The Search for Player screen displays.
Enter part of a player's name in the Player Name field and click Search, or select a name from the Player Name drop-down menu.
Alternately, select from the All Existing Players list.
Click Create New Player to add a new player.
4 Click Save Player Selections.

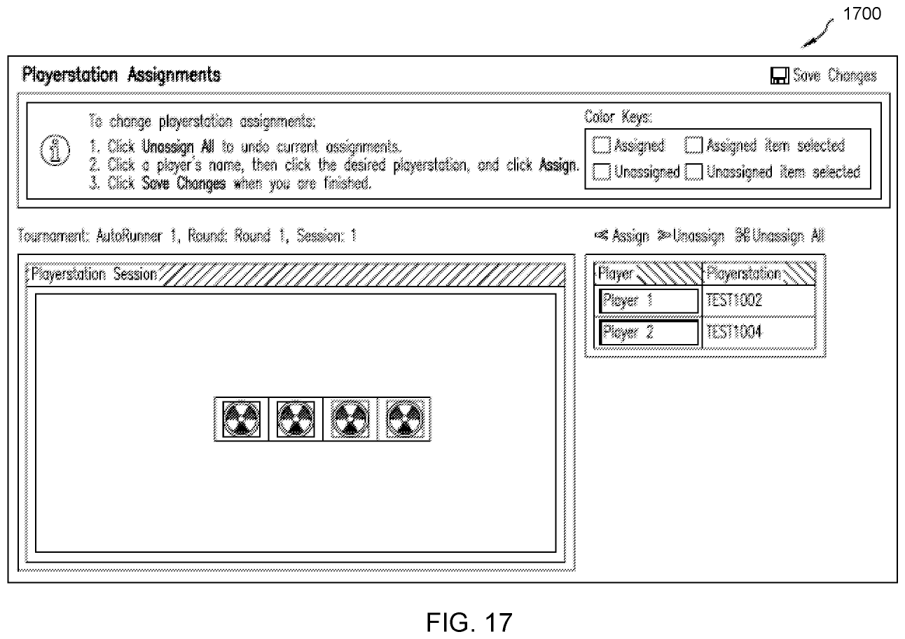

Referring again to FIG. 8 and also FIG. 17 showing a player station assignment screenshot 1700, a user may change gaming machine 103 assignments as follows:
1 From the list of active tournaments, click on the appropriate row. The Tournament Control screen displays.
2 Under Rounds & Sessions, click. The Playerstation Assignments window displays.
3 Click Unassign All to undo all player station assignments. To change a player's player station assignment, click the player, click Unassign, then select the desired player station and click Assign. If another player is already assigned to the desired player station, that player will need to be unassigned first.
4 Click Save Changes to save the new player station assignments and return to the Tournament Control window.
5 To move a player from one session to another, click the player's name and drag it to the desired session.
6 To add or remove player stations to or from a session, click in the session heading, then make the necessary changes in the Edit Session Profile window.
7 To edit a player's name and/or to activate or deactivate the camera on his/her player station, click next to his/her name, then make the necessary changes in the Edit Tournament Player window.

Referring again to FIG. 8, a user may operate a tournament as follows:
1 From the list of Active Tournaments, click on the appropriate row.
2 Verify that the specifications on the Tournament Detail screen are correct. If the information needs editing, click Edit Tournament.
3 When the tournament specifications are correct, click Start Tournament.
4 Before you continue, verify that the screen displays the following message: OK: Successfully started Tournament ‘Tournament Name’ The screen might also display the following message: It may take a minute for the player stations to be ready to play before you can Ready Next Session.
5 Click Ready Next Session. The player stations display a welcome message to each player.
6 At the player stations, verify that the tournament game has registered and the System Locked notification displays.
7 Click Start Next Session. The player stations display a countdown, after which players can begin play.
8 For a multiple session round, at the player stations, verify that the tournament game has registered and the System Locked notification is displayed.
9 Click Ready Next Session. The player stations display a welcome message to each active player.
10 Click Start Next Session. The player stations display a countdown, after which players can begin play.
11 If a session must be replayed for any reason (such as a player station rebooting, for example), click Replay Session to replay the previous session without having to recreate it.
At the end of the tournament, the player stations display the message TEMPORARILY UNAVAILABLE while the system records the results.
12 Click End Tournament.

In one or more alternative embodiments, competitive play may be conducted through individually timed trials, heats, or entries wherein each player may play at different times and post a score to compete against other players who may be provided the opportunity to play during a selected period of time, such as over the course of a morning, afternoon, evening, day, weekend, week, month, etcetera. Such competitive play may be conducted in-revenue or out-of-revenue, and may be initiated such as by a player electing to play a tournament that may be offered on a display menu. In the case of an in-revenue competition, there may or may not be an additional entry fee required. Once a competition is selected by a player at gaming machine 103, the leader board may be displayed on display 113 and player dashboard such as that shown at 2803 in U.S. Pat. No. 9,443,394 may be displayed on display 115.

One or more example embodiments may enable a player to qualify for a tournament at any time. For instance:
Step one: player is playing an in-revenue spinning reels games.
Step two: the player is prompted to participate in a slot tournament or the player can select a button on the machine to indicate they want to participate. Prompting may occur from a network server (e.g. tournament server or controller, such as described herein) programmed to receive game play information and to send a message to be displayed at respective gaming machines according to one or more criterion (such as, player card inserted, game play activity identified or player tracking information). Alternatively, each participating gaming machine may include programming executed by a processor (such as the game processor or player tracking controller, e.g. Bally iView™ controller or display manager) to display a menu (such as, when a player card is inserted or when gaming activity occurs) including a tournament option that when selected by a player initiates a request from the gaming machine to a tournament controller which may respond as to the availability of and information about one or more tournaments in which the player may participate.
Step three: a pop-up message shows up on the primary game where the player see the tournament rules, and how much it costs to play, and the prizes and has to “accept” in order to play.
Step Four: The player pays $5 worth of credits to participate and then the game goes out of revenue into the tournament play.
Step Five: The player plays as many games as they can and wins as much as they can in 2 minutes.
Step Six: If the player wins a certain number of points during the tournament they win an instant cash prize.
Step Seven: If the player gets enough points they qualify for a “live” tournament at the end of the day or week or month.

Another embodiment includes enabling the player to be paid based on what place they finish and there are fixed prizes for what place they finish in. For example, the player is playing on their own and they get 100,000 points in tournament play which is equal to 9^{th} place and pays $25. First place could be a progressive. Thus the player is playing against established positions versus other players. For example, a player with a player card may play and earn a place in the tournament; after the tournament concludes, credits may be applied to the player account which may be accessed when the player returns to play or goes to a cage at the casino, provides identification and requests the credits to be cashed out. In some tournaments or competitions, the credits may be non-cashable so the player may only be able to obtain a non-cashable credit coupon. In the non-cashable credit coupon case, the credits may only be available for play on a gaming machine or possibly for other purchases or table wagering within the casino operator's premises.

The payments for any of the tournament or competition embodiments may be made from a percentage of coin-in from all the games or gaming machines (or all the eligible games or gaming machines eligible to participate in the tournament, competition, or qualifying) on the system. Alternatively, a casino operator or competition/tournament sponsor may fully fund a winnings pool from which winners may be paid; in which case, if entry fees are collected, they may be used to defray a tournament cost or potentially make the tournament profitable. Another alternative, the operator or sponsor may seed a pool (e.g. $10,000) and entry fees may be used to increase the pool from which winners may be paid; or the pool may simply be built with entry fees and/or a percentage or function of coin-in, coin-out or handle.

At any time during respective competition periods, tournament (or competition) leader boards may be posted for respective tournaments on one or more overhead displays or display panels which may be positioned at various locations, such as against a wall or near a player service center at one or more gaming facilities. Other locations where leader boards may be posted may include commercial websites, such as a gaming facility's website (e.g. Harrah's, Boyd Gaming, MGM, Wynn) or social network websites (e.g. Facebook®, Twitter®, You Tube®). Gaming operators may set up web pages on its website for its players or for the general public, may enter tournament information and updates, may enable tournament information (such as leader boards, remaining time for tournament participation, beginning times for upcoming tournaments, etc.) to be accessed by registered players and/or the general public, and may enable users (e.g. players or visitors) to establish user accounts and to use their accounts for various purposes (such as: to sign up for a tournament, to play a game or tournament online, to reserve a designated gaming machine at a facility at a specified time, or to receive tournament updates by voicemail, text and/or email to a telephone (e.g. a cell phone or land line), a personal computer, or, a voicemail, email, or text (e.g. SMS) account).

In cases when a player elects to sign up for a tournament, play a game or tournament online, or reserve a designated gaming machine, a fee may or may not be required to be paid. In cases when a fee is required, a user may use a credit card or player account to pay the associated fee. For example, a player may accrue player points in a player account that may be redeemable to use to pay a tournament fee. In the case when a player reserves a designated gaming machine at a pre-specified time, the operator may enable its server network to transmit information to the designated gaming machine that may disable the gaming machine until the player's card is entered into the card reader on the designated gaming machine or until a predetermined amount of time has passed, such as fifteen minutes. At the end of the predetermined time, the gaming machine may be re-enabled and the player may or may not forfeit a reservation fee. If the player enters the player's card into the card reader within the predetermined time period, a reservation fee paid at the time of making the reservation may or may not be credited to the credit meter or player account. If the reservation fee or a portion thereof is either added to the credit meter or the player's account, the credits may be redeemable for cash or may be used for play only.

In one or more embodiments, competitive play may be initiated on a conventionally provided primary game or a game specific to the competition (depending upon the competition rules), which may be stored onboard or remote to, executed by, and/or transmitted to gaming machine 103 in a similar manner as described herein.

Referring to FIG. 18, a block diagram of example networked gaming system 1800 associated with one or more gaming facilities is shown including host server 1807 connecting to a set of backend servers and floor server 1805 which in turn connects to a network of gaming machines 103 including one or more convertible in-revenue/out-of-revenue gaming systems 100 in accordance with one or more embodiments. Each of the convertible in-revenue/out-of-revenue gaming systems 100 includes control center server 101, one or more banks of the networked gaming machines 103, and overhead display 111 (optionally) operably connected to automatically convert the gaming operating mode of each of the banks from in-revenue to out-of-revenue and vice-versa as described above.

As shown in FIG. 18 one or more overhead displays 111 and one or more control center servers 101 may be network connected through Floor Server 1805 to Host Server 1807 which in turn connects to various back-end servers, such as player account server 1808, accounting server 1809, progressive server 1810, web server 1811, game server 1821, and central determination server 1823 (the latter being employed in the case of Class II gaming operations for example).

In one or more embodiments, game server 1821 may provide server-based games and/or game services to network connected gaming devices, such as gaming machines 103 (which may be connected by network cable or wirelessly). Progressive server 1810 may accumulate progressive awards by receiving defined amounts (such as a percentage of the wagers from eligible gaming devices or by receiving funding from marketing or casino funds) and provide progressive awards to winning gaming devices upon a progressive event, such as a progressive jackpot game outcome or other triggering event such as a random or pseudo-random win determination at a networked gaming device or server (such as to provide a large potential award to players playing the community feature game). Accounting server 1809 may receive gaming data from each of the networked gaming devices and perform audit functions. Player account server 1808 may maintain player account records and persistent data such as accumulated player points. With reference to FIG. 18, while a few servers have been shown separately, they may be combined or split into additional servers having additional capabilities. In particular, the controller functions provided by central control server 101 may be performed by floor server 1805 or some other physical data processing system included in networked gaming system 1800.

In one or more embodiments, networked gaming system 1800 may include web server 1811 connected to a public web network, such as worldwide web (WWW) network 1813. Community Website 1815 may externally connect through network 1813 to web server 1811 through a firewall in order to provide access by networked gaming system 1800 to player information, such as a player's community website game or associated points obtained from non-wagering gaming activity. Such a service, for example, may be offered to a casino operator on a fee basis or through a subscription service with the community website provider, whereby a casino operator may access a player's records, view a player's activity at community website 1815, and choose, based on the player's activity, to offer or provide promotional credits or incentives to the player at the casino operator's facilities.

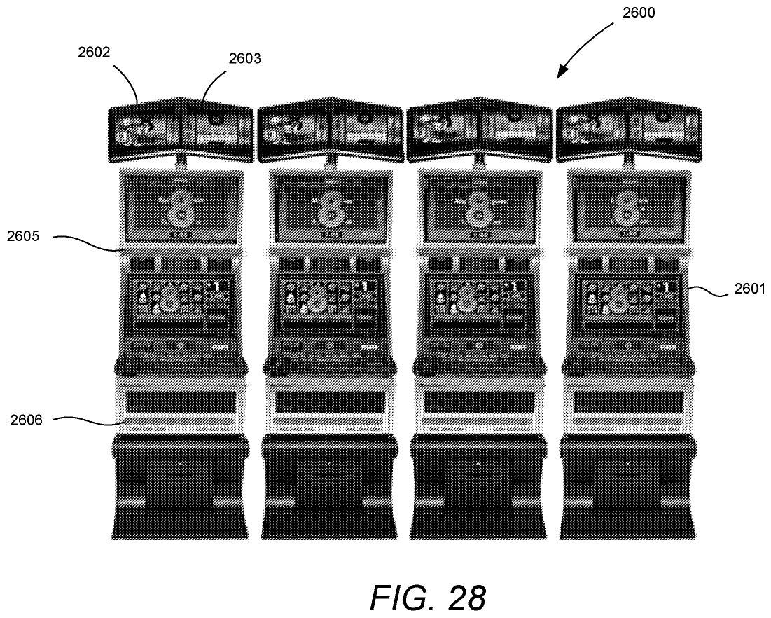

Community website 1815 may offer players a variety of games to play including a tournament or other competitive game which may be operated substantially as disclosed above. For example, the website may include a menu of available games which may include tournament or tournament qualifying games that may be played at the request of a player-visitor to community website 1815. In these examples, one or more tournaments or competitions may be programmed, such as through control center server 101 as substantially described herein or a server hosting community website 1815, and made available for participants to enroll (such as by paying a fee using a credit card or, if no fee is required, by simply entering a player name) and play a game associated with a selected tournament or competition during an active period of the selected tournament or competition, such as during a 24 hour, 1 week, or 1 month period. The scores achieved by each of the participants during the active tournament or competition period may be posted on a leader board that may be displayed on Community Website 1815. Each participant may play the associated game on personal computer 1831 or wireless device 1833, such as an iPad® tablet or, an iPhone® or Blackberry® phone, personal data assistant, etc. which may connect through internet 1813 to Community Website 1815. Each participant may use the associated keyboard or touchpad of their internet device as a user interface to perform the functions of a button deck on gaming machines 103 and view the game (such as a five-reel video game, e.g. FIG. 4) through the associated display. In one or more embodiments, in addition to the conventional game play initiated by pressing the play button (e.g. ‘enter’ button on player keyboard), random or pseudo-random interactive bonus features may display on or about the game display and player may have the opportunity to score additional points by popping or selecting one or more items (e.g. balloons, FIG. 28 of U.S. Pat. No. 9,443,394), such as by pressing the ‘space’ bar.

While playing, if the participant has a video camera operational, the participant's video stream may be displayed on a webpage of Community Website 1815 along with a real-time updated score and position on the leader board. Also, any other participants who may be playing in the selected tournament or competition, may have their video, score, and position displayed either simultaneously with the other participants or on a rotational basis. Depending upon the size of the participant's display, a portion of the player's screen may be used for the game while another portion may show the leader board and participant videos.

After a participant's game play, each participant's score may be posted, along with a name (which may be a player selected pseudonym) and picture (which may be a captured image or images from the video camera, a player uploaded still image, or a player selected avatar still or video image such as from a set of avatar images available through Community Website 1815 or player uploaded). Once the period of the tournament or competition has passed, awards may be posted or credited to player accounts of winning participants and redeemed, such as by the winning participant requesting a credit be applied to a player's credit card account or a player card account associated with a gaming operator (e.g. MGM, Wynn, TI, Caesar's Palace, Mandalay Bay, etc.).

The tournaments or competitions as described may be played on demand by a participant, in which case players may be provided a window of time in which to play in the tournament or competition, such as a day, week, or month. Alternatively, the tournaments or competitions may be scheduled as described herein by programming such as through the use of control center server 101 and played on a scheduled basis with a fixed start and stop time. Tournaments or competitions may be played in sessions or at one time. Tournaments or competitions may include several heats, such that winners from sessions in a first heat may advance to play in a second heat and so forth until a final heat is completed to determine the winners.

In either the on-demand or scheduled tournaments or competitions, participants may qualify to participate in follow-on tournaments or competitions which may be played online (such as at Community Website 1815) or at a physical location, such as a designated casino facility (e.g. Wynn, Caesar's Palace, Mandalay Bay, etc.). For example, winners online may receive an expense paid trip to the Wynn for a weekend plus an invitation to play in a tournament at the Wynn with a chance to win various additional prizes and awards. Similarly, online winners may qualify to participate in further online tournaments with additional prizes and awards.

In one or more embodiments, a selected tournament or competition may be programmed to play in-revenue. For example, at the beginning of the tournament or competition play, a player may be prompted to add a specified amount to the credit meter (e.g. $100). When tournament or competition play is initiated, maximum bets may be played until the designated time of play ends or the player's credit meter goes to zero. The leader board position may be determined by the amount of credits on a player's credit meter during course of play (for example, if the tournament or competition has a scheduled start and stop time) until the end of play when the winning players are determined based on ending positions. In the case of an on-demand tournament or competition, a player may select the tournament or competition to be played, apply the required credits to the credit meter, and play the game with maximum wagers until the game play time period expires. In one or more embodiments, a player may not be required to apply maximum bets to each game play. For example, if a player is able to determine that the player has sufficient credits on the credit meter to place in the tournament or competition, the player may adapt a strategy to make minimum bets needed to finish the tournament or competition. At the end of the tournament/competition, the player's credit meter may be incremented by an award from the tournament/competition based on the participant's place on the leader board in the case of a scheduled tournament/competition. In the case of an on-demand tournament/competition, a participant's account may be incremented at a later time based on the participant's placement at the end of the tournament/competition playing period.

In one or more embodiments, a selected tournament or competition may be programmed to play out-of-revenue. For example, a player may pay an entry fee to enroll in a selected tournament. When the tournament is ready to begin, either initiated by the player in an on-demand tournament/competition or by the server in a scheduled tournament/competition, the game display shows the tournament game (such as a five-reel video game, e.g. FIG. 4) and an initial score (e.g. 10000 credits/points) on the credit meter. Once the game begins, the player may press the play button (or associated button on the player's keyboard) and depending upon the game outcomes, the score on the credit meter may increment. Conventionally, the credit meter is not decremented for each game play as may be the case for in-revenue game operations.

In the case of out-of-revenue tournaments or competitions, awards may be provided by a sponsor (such as a casino operator) or the website operator from marketing funds, entry fees, or a combination thereof. In the case of in-revenue tournaments or competitions, the tournament or competition award pool may be similarly funded and/or be funded by a portion of coin-in, either during regular non-tournament/competition play, during tournament/competition play, or a combination thereof.

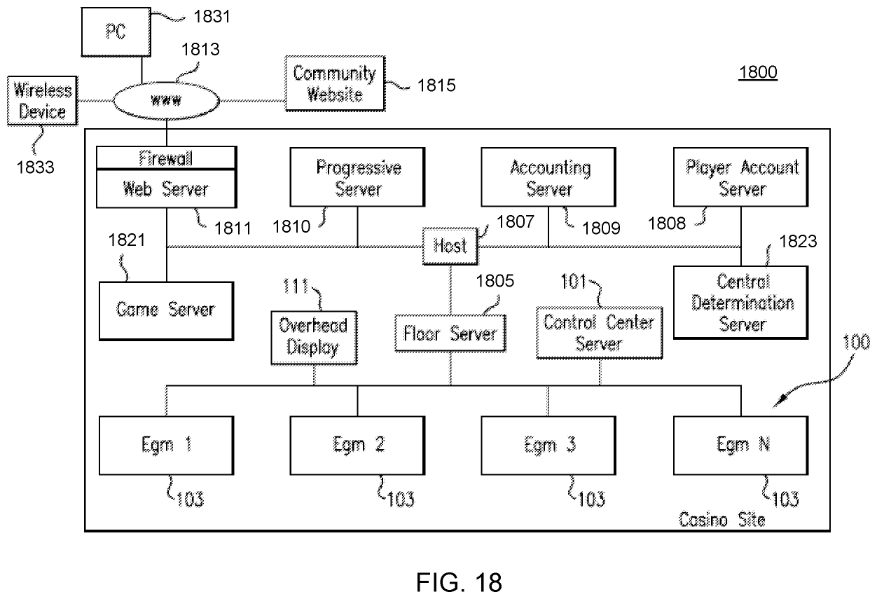

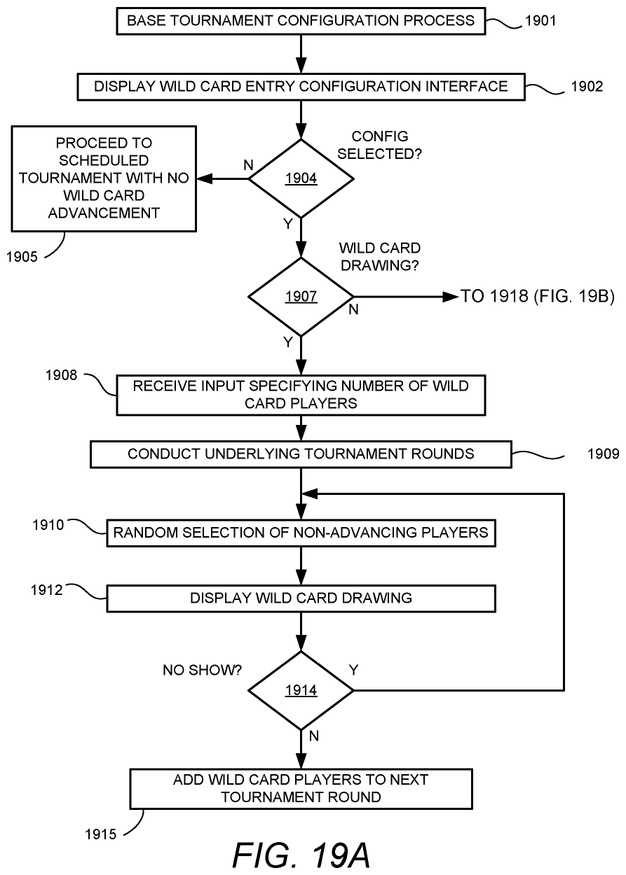

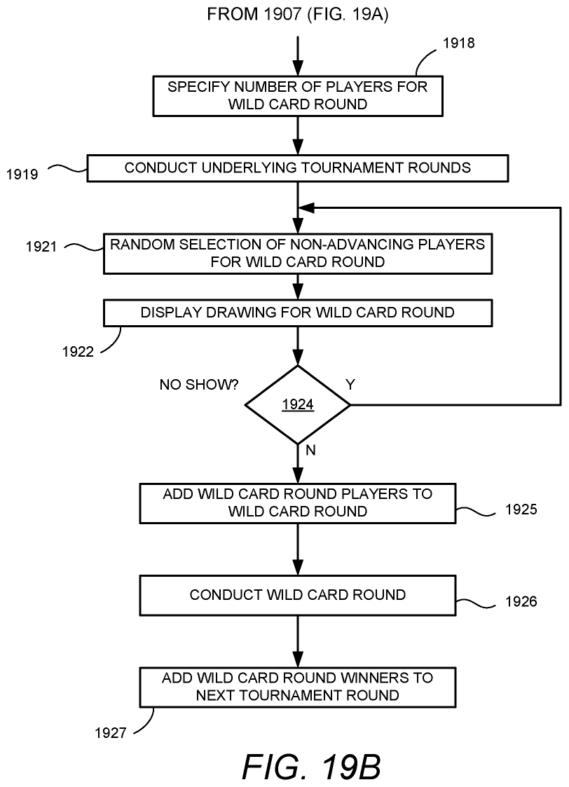

FIGS. 19A and 19B show a process for configuring a wild card entry arrangement for a tournament gaming system. The wild card entry arrangement allows one or more players to advance to a subsequent round in the tournament even though they do not otherwise qualify for advancement in the tournament. Failure to qualify for advancement would typically be due to the player's relative score in a given tournament round.

The process shown in FIG. 19A begins with a base permit configuration process as shown at process block 1901. Thus the process shown in FIG. 19A assumes that the wild card configuration is a separate process conducted after the underlying tournament is configured. Of course, the wild card configuration process shown in the figures may be incorporated into the base tournament configuration process and need not be conducted as a separate process after a base tournament configuration.

The process includes displaying a wild card entry configuration interface as indicated at process block 1902. This interface will include suitable controls (which may be touch screen controls for example) for enabling the operator, typically authorized casino personnel, to select whether or not wild card entry is to be enabled for a given tournament and if so, the characteristics of the wild card entry process. In the event the operator does not wish to include wild card entry for the given tournament as indicated by a negative outcome at decision box 1904 the process simply proceeds to the scheduled tournament with no wild card advancement as indicated at process block 1905. The illustrated process supports two different types of wild card advancement, advancement through a wild card drawing and advancement through a wild card round of additional play. Thus the process includes determining which type of wild card advancement is desired between wild card drawing and a wild card round types. In the event the operator selects wild card drawing advancement as indicated by an affirmative outcome at decision box 1907, the process includes receiving an input indicating the number of wild card players for the given wild card advancement configuration as shown at process block 1908. This input indicates the number of non-advancing players (players who did not qualify for advancement under the underlying tournament rules) to be advanced as wild card players for another round in the tournament.

Once number of wild card players to be included for the given tournament or round in a tournament is received, the process includes playing through the tournament at the various gaming machines participating in the tournament as indicated at process block 1909. Play continues until the point at which advancement in the tournament is determined in accordance with the tournament rules. Once the advancing players are determined in accordance with the tournament advancement rules (that it, the rules aside from the wild card advancement), the process includes making a random selection of wild card players from the otherwise non-advancing players. This process includes conducting a random selection from among the subset of players that participated in the earlier portion of the tournament but were not identified as advancing players. This selection of non-advancing players (which may be referred to as a “wild card drawing” may be displayed on a suitable display device such as the overhead display 111 described above.

The example process shown in FIG. 19A includes determining whether the randomly selected wild card players selected to advance to the next tournament round are present at the appropriate time at a tournament gaming machine to participate in that round. If any of the wild card players selected in the step shown at process block 1910 are not present or do not acknowledge their selection within a specified time as indicated by an affirmative outcome at decision box 1914, the process loops back to make another random selection from the remaining non-advancing players to include in the wild card players advancing to the next round. However, where a player selected at process block 1910 appropriately acknowledges their selection, the process includes adding the selected players to the next tournament round along with the players that advanced to the round by virtue of their play in the previous round. This step is shown at process block 1915 in FIG. 19A.

The appropriate acknowledgement required to prevent branching back for another wild card player selection, and thus the loss of right to advance as a wild card player, may comprise any suitable action which may be taken as an acknowledgement. For example, the act of going to a tournament gaming machine and logging in or swiping or inserting an identifying card may serve as acknowledgement. Alternatively, a gaming system implementing the illustrated wild card selection process may require a selected wild card player to go to a tournament operator station (such as control center server 101 described above) to acknowledge their availability as a wild card player and desire to participate.

FIG. 19B shows a portion of the process for configuring wild card entry not through a wild card drawing as shown in FIG. 19A, but instead through a wildcard round of tournament play between players selected from the non-advancing players in the previous round. This branch of the process would be selected by a suitable entry by the operator selecting between the wild card drawing option and the wild card round option.

If the wildcard round option is selected as indicated by a negative outcome at decision box 1907 in FIG. 19A, the process includes receiving an input to specify the number of players to be included in the wild card round for the given configuration. Once this input is received as indicated at process block 1918 the process includes playing through the underlying tournament to reach the point at which the underlying tournament rules define advancing and non-advancing players. This process shown at 1919 corresponds to process block 1909 in FIG. 19A. Once the advancement determination point is reached so that non-advancing players may be identified by the system, the process includes randomly selecting non-advancing players for the wild card round as shown at process block 1921. The selection for the wild card round of play may be displayed as indicated at process block 1922. This display as well as wild card round play itself may be provided through suitable overhead display such as display 111 described above.

Similarly to that shown in FIG. 19A, the process illustrated in FIG. 19B includes an arrangement for determining if a player selected for the wild card round is not available for the round. If a player is determined to be unavailable as indicated by an affirmative outcome at decision box 1924, the process simply loops back to perform another selection of a non-advancing player for the round. However, once all of the non-advancing players selected for the wild card round have acknowledged their selection and desire to compete in the round, the process includes adding the selected players to the wild card round as indicated at process block 1925. The wildcard round is then conducted as shown at process block 1926, and the configured number of wild card round winners (according to some standard defined in the system) are advanced to the next round of the tournament as shown at process block 1927.

The configuration and control indicated by the processes shown in FIGS. 19A and 19B may be accomplished through a suitable tournament controller comprising one or more processors executing suitable program code to effect the processes. For example, control center server 101 described above may provide the various operator interfaces, and may execute the code to perform or support the various functions shown in FIGS. 19A and 19B.

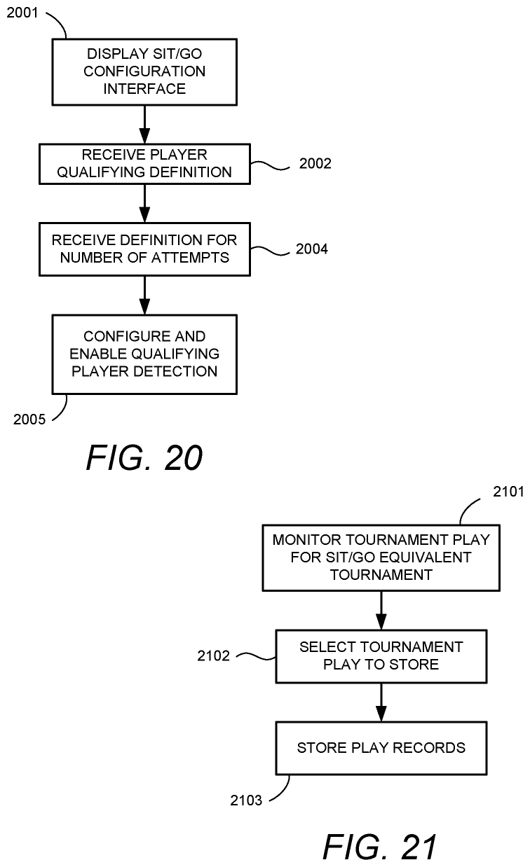

FIGS. 20-22 may be used to describe a “sit-and-go” (abbreviated “sit/go”) tournament configuration and operation in which tournament players play their tournament rounds at different times rather than concurrently as in a standard tournament. FIG. 20 shows a configuration process which includes displaying a sit/go configuration interface for a system operator such as authorized casino personnel. This configuration interface may be displayed as shown at process block 2001 at the tournament control terminal such as an interface of control center server 101 described above. The illustrated process includes receiving a player qualifying definition, that is, a qualifying parameter definition, as shown at process block 2002. This qualifying definition defines which players may participate in the given sit/go tournament. The definition may be based on any suitable parameter including in terms of player club or player tracking points which represent qualifying parameter values associated with the player owing the player club or tracking account. In the case of player club or player tracking points, only players registered in the player club or player tracking system and having collected a certain number of points may qualify for participation in a sit/go tournament. The process shown in FIG. 20 also includes receiving a definition for the number of attempts for the given sit/go tournament as shown at process block 2004. For example, a sit/go tournament may be configured to allow each qualifying player only a single attempt, that is, a single instance of the tournament round (perhaps over a given time period such as a week), or multiple attempts to produce the ultimate score for that tournament and that player. The number of attempts may vary from player to player for a given sit/go tournament. For example, the number of attempts allowed may depend upon the player's qualifying definition. Continuing with this example, and the previous example in which the qualifying definition is based on player club or tracking points, players with higher player club or tracking points may be allowed multiple attempts for a given sit/go tournament whereas players with relatively lower player club or tracking point totals may be allowed only a single attempt to produce their tournament score. Ultimately the process shown in FIG. 20 includes configuring and enabling qualifying player detection as shown at process block 2005. This step may include setting any qualifying definition as a comparison value for incoming sit/go tournament play requests, and, as part of this definition, setting a number of attempts value as a comparison value for determining if the player has attempts remaining.

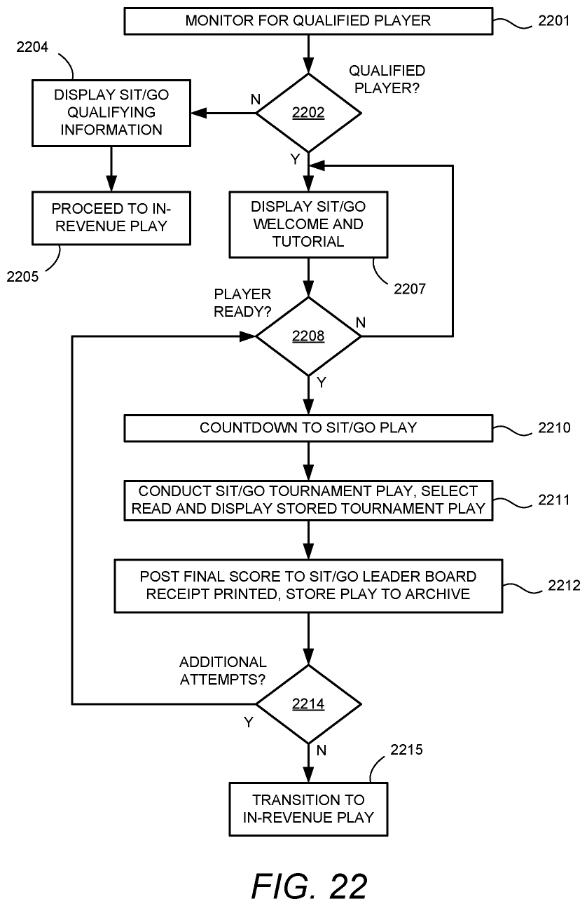

As will be described further below in connection with FIG. 22, sit/go tournament play includes individual tournament players playing their current rounds at times of their own choosing independent of any other players that may be participating in the tournament. However, even though different players may be participating at different times, implementations of sit/go tournaments may still display competitive play elements such as leaderboards during the course of individual play. This display of leaderboard information may be accomplished by displaying previously stored tournament play information. This tournament play information may be obtained from actual play in the same tournament or an equivalent tournament or may be theoretical play for the game design of the tournament game or games in question. FIG. 21 shows a process for obtaining actual play information for use in displaying competitive tournament information in the course of a later sit/go tournament round. The process includes monitoring for play in a game the same as or equivalent to the game for a given sit/go tournament as shown at process block 2101. This step may include detecting when a qualifying player begins a given sit/go tournament round or may include a regular concurrent tournament round (non-sit/go) for the same or equivalent game design. As shown at process block 2102, the illustrated process may include selecting tournament play to store. This selection may be made when it is not desired or necessary to store all of the tournament play for use in providing sit/go tournament competitive play information. In any event, the play records are stored as indicated at process block 2103. The play records may be stored in any form suitable for later use as described below in connection with FIG. 22. Stored play records may include a time element with the player's score recorded at various points in time. This information of players score over time may be used to display a leaderboard which shows player scores as if players were competing concurrently in the given sit/go tournament.

The process shown for example in FIG. 22 shows how a sit/go tournament is conducted in one implementation. The process includes monitoring for a sit/go tournament request from a qualified player as shown at process block 2201. If a sit/go tournament request is received from a non-qualifying player as indicated by negative outcome at decision box 2202, the process may include displaying sit/go qualifying information at the respective gaming machine (or other device) from which the request was received as shown at process block 2204. This display may simply indicate for example the level of points required as set in the qualifying definition shown at process block 2002 FIG. 20. After this display, the process may include returning or proceeding with regular in revenue play as shown in process block 2205.

If it is determined that the sit/go tournament request is from a qualifying player as indicated by an affirmative outcome at decision box 2202, the process may include enabling the gaming machine for tournament play, which may include providing a sit/go tournament welcome display and tutorial as shown in process block 2207. The player may have the option of skipping the tutorial by making a suitable input at their gaming machine indicating that they are ready to begin sit/go play. If the player does not skip the tutorial, the player may be deemed ready to play simply at the end of the tutorial. When the player is deemed ready to play as indicated by an affirmative outcome at decision box 2208 the process includes beginning a countdown to the sit/go round. This countdown shown at process block 2210 may be displayed in a suitable fashion at the players gaming machine. Tournament play begins at the end of the countdown as indicated at process block 2211. During the course of play, previously stored play records such as those stored according to the process shown in FIG. 21 may be read and used to display competitive tournament information such as leaderboard information during this instance of sit/go play. Once the sit/go tournament play is complete for the given round, typically according to a timer for that round, the process includes posting the player's sit/go tournament play record to a leaderboard for the sit/go tournament as shown in process block 2212. The gaming machine may also print a receipt for that sit/go tournament round and store that play record to an archive along with other stored play records such as those stored at process block 2103 in FIG. 21. If the player is allowed additional attempts as indicated by an affirmative outcome at decision box 2214 the process loops back to determine whether the player is ready for play in the sit/go tournament. Otherwise, the gaming machine may transition back to in-revenue play as indicated at process block 2215. Of course, if the gaming machine was in tournament mode at the time of the sit/go request, it might stay in tournament mode at the conclusion of sit/go play.

The monitoring indicated that process block 2201 may be performed by the tournament controller (such as control center server 101 described above) in some implementations of the invention. For example, a gaming machine may include a player control for enabling a player to request play in a sit/go tournament. Such a control might be a virtual or physical button that may be pressed by the player. Alternatively, simply swiping or otherwise inserting a player club card in a player input device comprising a card reader at the gaming machine may be deemed as a request for sit/go tournament play. This type of input allows the player to be identified by the system. In any event, the input/request at the gaming machine represents a qualifying parameter input which may be communicated to the tournament controller which determines whether the player is qualified or not and communicates a resulting signal back to the gaming machine at which the request was initiated. As noted above, the determination here comprises determining if one or more qualifying parameter values associated with the request satisfy the qualifying parameter definition stored in memory accessible to the tournament controller. The gaming machine may respond to the signal by either proceeding to process block 2204 if the player is not qualified or 2207 if the player is qualified for sit/go play. If the gaming machine was not in tournament mode at the time of the request, the gaming machine may also transition to tournament mode from in-revenue mode. Of course, if the gaming machine was already in tournament mode, the gaming machine would simply remain in tournament mode. The steps shown from process block 2207-2215 may be performed by processors associated with the gaming machine either alone or in cooperation with remote systems such as the tournament controller. For example, when it is determined that the player is ready to start sit/go play, the gaming machine may communicate a request to the tournament controller for stored play information to be used to display as indicated at process block 2211. This information may be communicated to the gaming machine as a complete set of play and then processed accordingly at the gaming machine, or may be communicated from the tournament controller over the course of sit/go play to produce the desired displays mimicking competitive, concurrent play.

It should be appreciated that the leader board referenced at process block 2212 in FIG. 22 represents the leader board information maintained for that sit/go tournament. This information generally will not correspond to the information displayed over the course of play in the sit/go tournament as indicated at process block 2211. This is so because the leader board displayed for sit/go play at a gaming machine may simply mimics actual leader board information whereas the leader board indicated at 2212 in FIG. 22 is the actual leader board for the given sit/go tournament.

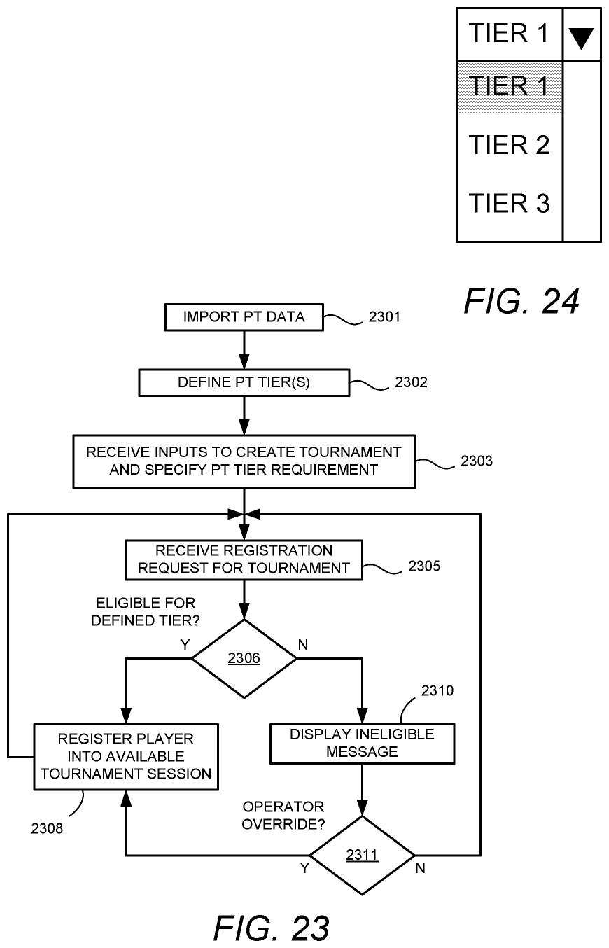

FIGS. 23 and 24 may be referenced to describe a selective tournament or VIP tournament configuration arrangement which allows a tournament operator to limit any given tournament to certain types of players. Any suitable parameter may be used to distinguish players for defining tournament qualification. The particular example shown in FIG. 23 defines player qualification in terms of player tracking or player club points. However, it should be appreciated that the invention is not limited to this parameter for selective player qualification.

Because the illustrated example employs player tracking data to define player qualification, FIG. 23 shows importing player tracking (PT) data as an initial step at process block 2301. This import of player tracking data may not be a single event but may include a continuous monitoring and updating of player tracking data at a tournament controller (such as control center server 101 described above). FIG. 23 also shows defining at least one tournament tier in terms of player tracking points as indicated at process block 2302. The definition indicated at 2302 may be received through a suitable operator interface at the tournament controller such as the interface console of control center server 101. This define a first tournament open to players have a player tracking point totals above a first level (first-tier), and, for example, a second tier open to players having player tracking points below the first-tier level but above a defined second-tier level. The tournaments at the different tiers may be for the same tournament game for different tournament games. The example process shown in FIG. 23 includes receiving operator inputs to create the desired tournament or tournaments and specify the player tracking tier requirement for that tournament.

Once the tier is created, registration requests are received for the various tournaments as indicated at process block 2305. These registration request may be received in any suitable fashion. For example, some tournament systems may require players to go to a kiosk or attended tournament registration terminal and submit a registration request either on their own or to an operator at the tournament registration terminal. Regardless of specifically how the registration requests are received for a given tournament, if it is apparent after acquiring the player tracking points for the player that the requesting player is eligible for a defined tier, the player is registered into the next available tournament at that tier as indicated at process block 2308. However, if the requesting player is not eligible for a defined tier as indicated by a negative outcome at decision box 2306, the process branches to display and ineligibility message as indicated at process block 2310. The nature of this message may depend upon the manner in which the registration requests are received for the tournament. If players register through an attended tournament registration terminal, the message may be a simple message that can be verbally communicated by the attendant to the requesting player perhaps along with information on how to become eligible. For an unattended kiosk or a gaming machine having an interface to request tournament registration, the displayed message may be more detailed and include information explaining how the player can become eligible for the requested tournament. In either case, the process shown in FIG. 23 indicates that a system operator may override a given determination of ineligibility and allow the requesting player to be registered into the desired tournament as indicated by an affirmative outcome at decision box 2311. After registration at process block 2308 or if there is no override, the process loops back to receive the next registration request for the subject tournament.

FIG. 24 shows a drop down menu that may be used to allow a terminal operator to specify a tier requirement for a given tournament. A separate control of the operator interface may be used to define the meaning of the different tiers. For example, tier one shown in FIG. 24 may have been previously defined as player tracking points over 50,000, tier two may have been previously defined as player tracking points over 10,000 (or over 10,000 and less than 50,000), and tier 3 may have been defined as player tracking points over zero (or more than zero and less than 10,000).

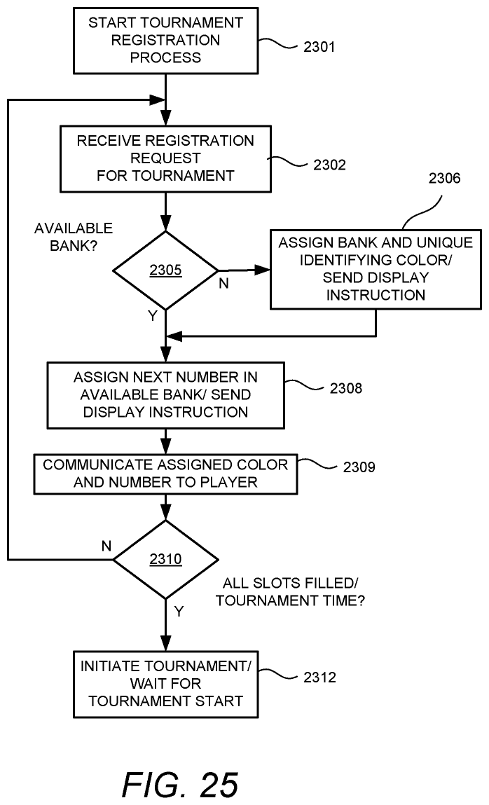

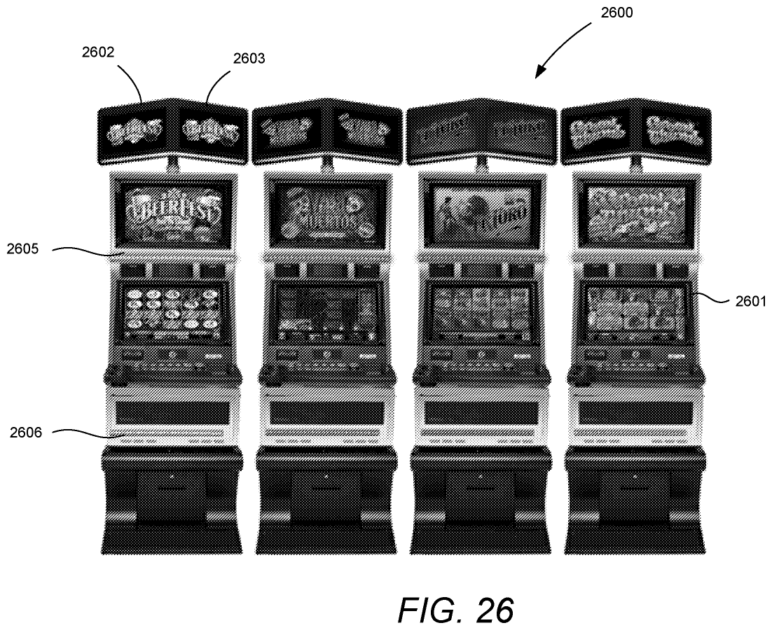

FIGS. 25 through 51 may be used to describe an arrangement for assisting tournament players in locating a gaming machine that has been assigned to them for play in a tournament. FIG. 25 shows a process that may be performed through the gaming system in connection with assigning gaming machines for tournament play, while FIGS. 26-51 show an example bank of gaming machines controlled according to the process.

The process shown in FIG. 25 is part of the tournament registration process as indicated at process block 2501. As a player registers for a given tournament as shown at process block 2502, the system inquires whether a bank of gaming machines is available or has been defined for the tournament already. If a bank is not available as indicated by a negative outcome at decision box 2505, that is, if a bank has not yet been assigned for the tournament or if the previously assigned banks have all been assigned players, the process includes assigning a bank and associating that assigned bank with a unique color as shown at process block 2506. The system may also send a display instruction to the assigned bank at this point to display the color assigned to that bank in a suitable fashion as will be described below in connection with the example gaming machine bank. If a bank is available with an unassigned gaming machine as indicated by an affirmative outcome at decision box 2505, or once a new bank and unique color has been assigned, the process assign a next available gaming machine in the bank along with a number uniquely identifying that gaming machine in the bank. This assignment step is shown at process block 2508 and may also include communicating a display instruction to the respective gaming machine to cause the gaming machine to display the identifying number. The assigned gaming machine number and the assigned color of the bank in which that gaming machine is included is also communicated in some fashion to the registering player as shown at process block 2509. This communication may be through a suitable registration receipt issued to the player for example. If all slots are filled for the tournament and/or the tournament registration time has expired, the process proceeds to initiate the tournament or wait for the tournament start time as the case may be. Otherwise the process loops back from decision box 2510 two received the next play registration request at process block 2502.

FIG. 26 shows a bank 2600 of gaming machines before they have been assigned and instructed to display a color or number or other identifier according to the process block 2506 and 2508 in FIG. 25. Thus the gaming machines 2601 are all shown operating in and in-revenue mode. It will be noted in FIG. 26 that each gaming machine 2601 includes a topper display arrangement including two display areas 2602 and 2603. Each gaming machine 2601 also includes an accent lighting arrangement. In this case the accent lighting arrangement includes an upper horizontal accent lighting band 2605 and a lower horizontal accent lighting band 2606. In the in-revenue mode shown in FIG. 26 the accent bands 2605 and 2606 display a color or colors consistent with the game operating at the gaming machine at that point in time. Topper displays 2602 and 2603 also display graphics or other information consistent with the in-revenue game offered through that gaming machine.

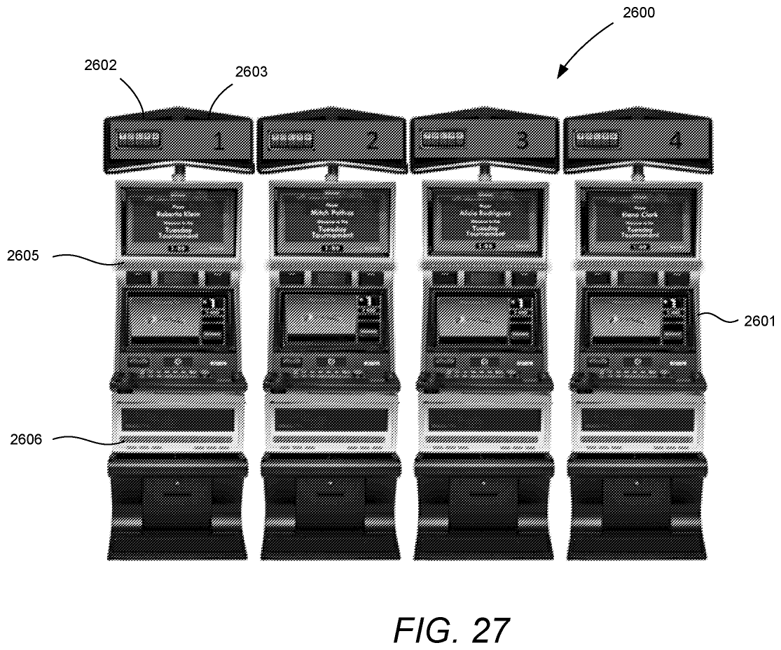

In the example of FIG. 27 the bank 2600 of gaming machines 2601 has been assigned a color and instructed to display that color in accordance with process block 2506 in FIG. 25. Also, each gaming machine 2601 shown in FIG. 27 has been assigned a number and instructed to display that number in accordance with process block 2508. Thus in this example, each topper display shows the color red assigned at process block 2506 and the accent lighting bands 2605 and 2606 likewise show this same red color. Furthermore, each topper display 2603 displays the number assigned at process block 2508. Thus, the player may use the information communicated at process block 2509 in FIG. 25 to readily locate the gaming machine 2601 to which they have been assigned for play in the tournament. First the player may locate the bank of gaming machines by the color assigned at process block 2506, and then within that bank locate their specific gaming machine 2601 through the number assigned at process block 2508 in FIG. 25. Once the player has located their gaming machine, they may simply wait for the tournament to begin at the gaming machine.

In embodiments where the gaming machine bank includes an overhead display arrangement such as overhead display 111 described above, the overhead display for a given bank may also be instructed and controlled to display the unique identifying color assigned to that bank. This may be in addition to or in lieu of the control of the topper displays or display showing the assigned color if such topper displays are present in the given gaming machine implementation.

FIG. 28 shows the bank 2600 of gaming machines 2601 at a point in time during a countdown to the tournament. In this example, each gaming machine 2601 may show the assigned color as part of the topper displays in addition to graphics associated with the tournament countdown. The accent light bands 2605 and 2606 continue show the assigned color.

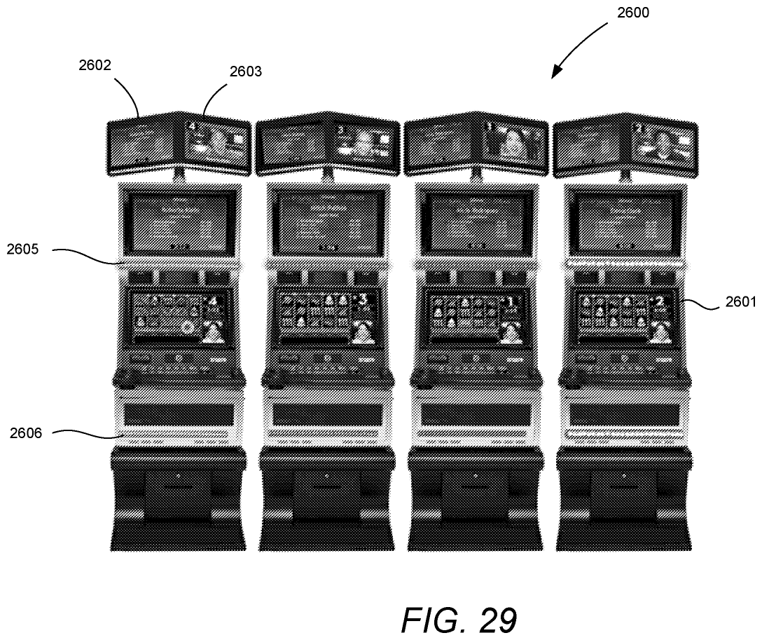

FIG. 29 shows the bank 2600 of gaming machines 2601 during the course of the tournament to which a player has been assigned in accordance with the process shown in FIG. 25. In this example the topper displays 2602 and 4003 show information such as leader board information and player video for the tournament. Topper displays may also at least partially show the assigned bank color. The accent lights 2605 and 4806 may be used to provide tournament information such as the position of the player in the tournament. That is, a color may be assigned for the first-place player, second place player, and so on, and these colors may be shown on the accent lights for the respective gaming machine to indicate the position of the corresponding player in the tournament.

It will be appreciated that the bank color and individual gaming machine identifying number are used only as an example in the above description. Unique identifiers other than color and numbers may be used to identify a particular bank of gaming machines and a particular gaming machine in that bank.

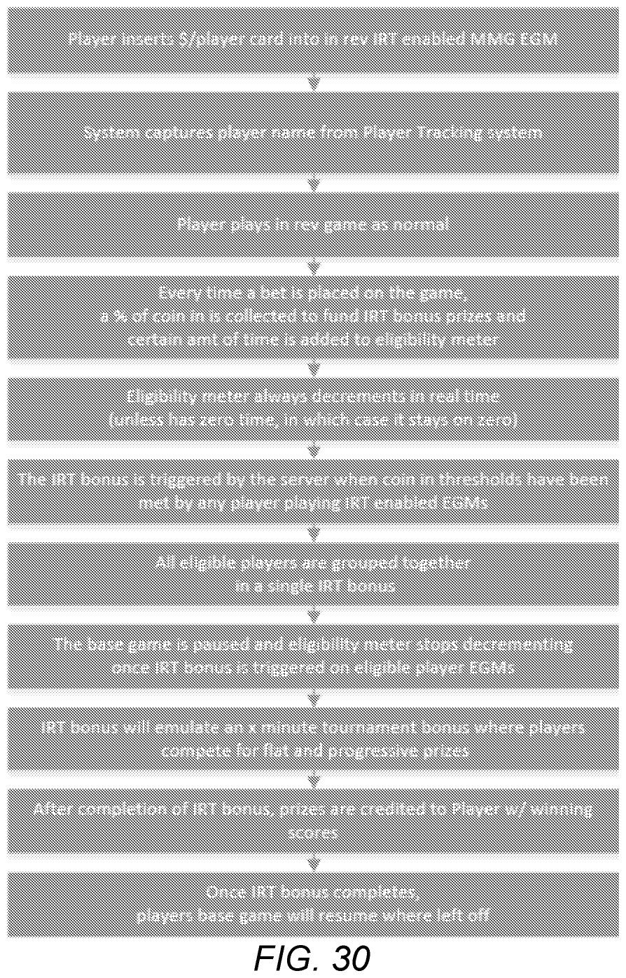

In Revenue Tournament (IRT) Community Bonus is a bolt on bonus engine that attaches to in revenue base games. An example process flow is illustrated in FIG. 30. Community Bonus simulates an out of revenue tournament in an in-revenue community bonus event. Base games can be run either with or without IRT bonus. Games that are configured to run IRT display content related to bolt-on bonus game on associated LCD toppers/signage. IRT bonus is capable of being configured at variety of payouts that is configurable by casino operator. Any play on an IRT enabled EGM (at any bet level) have a chance of triggering the bonus assuming player is eligible. Prizes awarded are determined by bonus game play on the top and bottom screens of eligible IRT EGMs. Prizes include flat pay and progressive awards. Bonus graphics overlay existing game assets with a dim layer between. Player interaction is required during the bonus by touching the EGM screens and/or the hardware PLAY button. After the bonus completes, the resulting prize value (dynamic content) and winning movie video display on available signage. The system provides safeguards against allowing games to exceed 100% payouts. For example, an add-on bonus with a 5% contribution will not be allowed on a base game with a 98% payout. The system checks to see if the combined payouts of the base game and add-on bonus is above the jurisdictional minimum payout requirement. The system is able to handle instances where the add-on bonus game is triggered at the same time as a base game bonus.

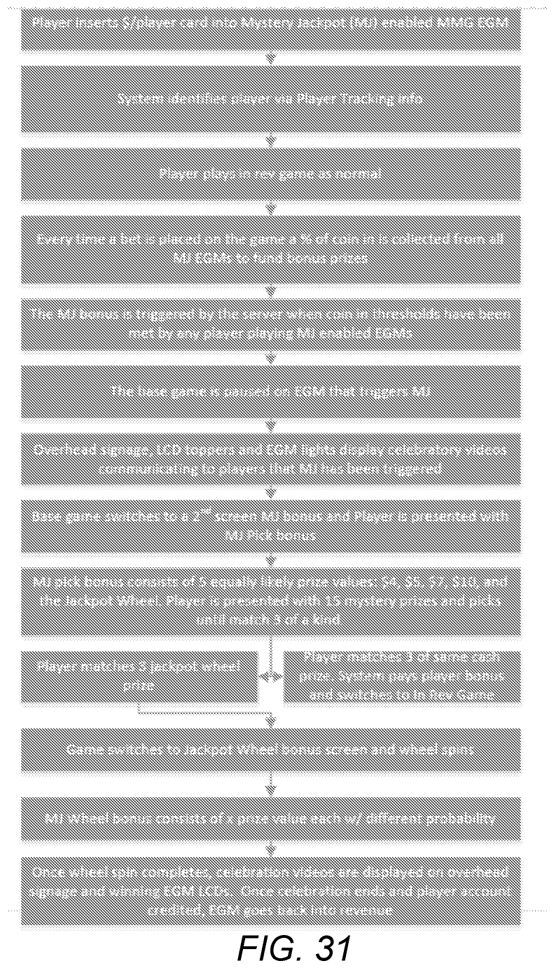

Mystery Jackpot (MJ) Bonus is a bolt on bonus engine that attaches to in-revenue base games. An example process flow is illustrated in FIG. 31. Base games can be run either with or without MJ bonus. Games that are configured to run MJ bolt-on bonus display content related to bolt-on bonus game on associated signage. Bolt-on bonus game is capable of being configured at variety of payouts that is configurable by casino operator. Any play on an EGM of a bolt-on bonus bank (at any bet level) have a chance of triggering the bonus as a mystery. At the end of a play (after bang up completes), the mystery bonus is announced on the triggering EGM only. Prizes awarded are determined by bonus game play on the top and bottom screens of the triggering EGM. Prizes include flat pay and progressive awards. Bonus graphics overlay existing game assets with a dim layer between. Player interaction is required by touching the EGM screens and/or the hardware PLAY button. After the bonus completes, the resulting prize value (dynamic content) and winning movie video should display on available signage. The system provides safeguards against allowing games to exceed 100% payouts. For example, an add-on bonus with a 5% contribution should not be added to a base game with a 98% payout. The system checks to see if the combined payouts of the base game and add-on bonus is above the jurisdictional minimum payout requirement. The system is able to handle instances where the add-on bonus game is triggered at the same time as a base game bonus.

Mystery Jackpot can be displayed in variety of bonus skins. Current examples for the bonus game are:

Money Bag/Community Hot Seat

Individual EGM pick w/ Wheel bonus

Money Bag/Community Hot Seat:

A moneybag cycles onscreen between possible award values, and then stops on a value to award (or the player could even be allowed to hit the play button or screen to determine when the moneybag stops, for a pseudo-skill-stop type of bonus).

The bonus can be mystery-triggered on the bank of EGMs at any random time by the server, based on recent bet history and RNG draw.

There is an eligibility meter for the bonus onscreen on each EGM, which is placed in a strip that runs along the bottom of the top screen (or possibly along the top of the bottom screen). This strip has 10 or so BONUS icons, some number of which light up from left to right to indicate the player's level of eligibility. Rate of play and bet level dictate how many BONUS icons are lighted at any given time. If the player stops betting, the BONUS icons will proceed to turn off one-by-one as time passes, until they have all turned off, indicating that the EGM is no longer eligible for the bonus. When the bonus triggers on the bank, all eligible EGMs immediately pause their base games and “light up” (using EGM lighting). Each EGM's current eligibility level (depicted onscreen as X out of 10 BONUS symbols) is now locked into place as well, and emphasized to the player with lights/video animations. There is a suspenseful countdown (10, 9, . . . 3, 2, 1) during which the “hot seat” cycles randomly amongst eligible EGMs. There is a cycling camera feed (shown on each EGM, and also on whatever available sign) which shows the camera feed of the currently-selected EGM, and the lights on the currently-selected EGM are simultaneously turned brighter. EGMs at higher eligibility levels generally get the hot seat longer and/or more often as it cycles, to depict that they are more likely to win. When the countdown reaches 0, the hot seat stops on a particular EGM, and a random bonus value is awarded to this EGM. No bonus game is played to determine the prize, it is just a random flat or progressive award value that pops up on the selected EGM.

Pick bonus w/ Wheel:

Player picks prize values until 3 of the same prize value are matched, and this is the prize that is awarded. There could also be a WILD pick result which opens up the possibility for multiple prizes to be matched (all of which would be awarded).

Referring generally to the forgoing description and to the following claims, as used herein the terms “comprising,” “including,” “carrying,” “having,” “containing,” “involving,” and the like are to be understood to be open-ended, that is, to mean including but not limited to. Any use of ordinal terms such as “first,” “second,” “third,” etc., in the claims to modify a claim element does not by itself connote any priority, precedence, or order of one claim element over another, or the temporal order in which acts of a method are performed. Rather, unless specifically stated otherwise, such ordinal terms are used merely as labels to distinguish one claim element having a certain name from another element having a same name (but for use of the ordinal term).

The term “each” may be used in the following claims for convenience in describing characteristics or features of multiple elements, and any such use of the term “each” is in the inclusive sense unless specifically stated otherwise. For example, if a claim defines two or more elements as “each” having a characteristic or feature, the use of the term “each” is not intended to exclude from the claim scope a situation having a third one of the elements which does not have the defined characteristic or feature.

The above described example embodiments are intended to illustrate the principles of the invention, but not to limit the scope of the invention. Various other embodiments and modifications to these preferred embodiments may be made by those skilled in the art without departing from the scope of the present invention.

1. A method of conducting a tournament in a gaming system, the method including:
(a) at a first gaming machine, receiving a first qualifying parameter input via a player input system of the first gaming machine;
(b) in response to the first qualifying parameter input, making a first qualifying communication to a tournament controller included in the gaming system;
(c) with the tournament controller, determining if one or more qualifying parameter values associated with the first qualifying communication satisfy a qualifying parameter definition stored in first memory accessible to the tournament controller;
(d) where the one or more qualifying parameter values associated with the first qualifying parameter input satisfy the qualifying parameter definition, placing the first gaming machine in an enabled state for a tournament game;
(e) conducting the tournament game through the first gaming machine to produce a first tournament score for a player of the first gaming machine; and
(f) at second memory assessible by the tournament controller, storing the first tournament score for the player of the first gaming machine.

2. The method of claim 1 wherein receiving the first qualifying parameter input via a player input system of the first gaming machine includes receiving a player identifying input.

3. The method of claim 2 wherein receiving the player identifying input includes reading a player card at a player card reader included in the player input system of the first gaming machine.

4. The method of claim 1 further including reading one or more scores from previously conducted tournament play in the tournament game from a stored score data storage device, and, during at least a portion of a time the first gaming machine is in the enabled state for the tournament game, displaying the one or more scores from the previously conducted tournament play in the tournament game.

5. The method of claim 1 further including at the first gaming machine printing a receipt for the tournament game conducted through the first gaming machine to produce the first tournament score for the player of the first gaming machine.

6. The method of claim 1 wherein placing the first gaming machine in the enabled state for the tournament game includes changing the first gaming machine from an in-revenue mode in which a wager is required for a play at the first gaming machine to an out-of-revenue mode in which no wager is required for play in the tournament game.

7. The method of claim 1 further including in response to completion of the tournament game through the first gaming machine to produce the first tournament score for the player of the first gaming machine, changing the first gaming machine from to an out-of-revenue mode in which no wager is required for play in the tournament game to an in-revenue mode in which a wager is required for a play at the first gaming machine.

8. The method of claim 1:
(a) wherein the qualifying parameter definition includes a value indicating multiple attempts available in the tournament game;
(b) after conducting the tournament game through the first gaming machine to produce the first tournament score for a player of the first gaming machine, determining if an additional attempt is available to the player of the first gaming machine; and
(c) where the additional attempt is available to the player of the first gaming machine, maintaining the first gaming machine in the enabled state for the tournament game;
(d) conducting the tournament game through the first gaming machine to produce a second tournament score for a player of the first gaming machine; and
(e) at the second memory assessible by the tournament controller, storing the second tournament score for the player of the first gaming machine.

9. The method of claim 1 wherein:
(a) the qualifying parameter definition includes a value indicating multiple attempts available in the tournament game; and
(b) determining if the one or more qualifying parameter values associated with the first qualifying communication satisfies the predetermined qualifying parameter definition includes determining if at least one more attempt in the tournament game is available to the player of the first gaming machine.

10. The method of claim 1 further including:
(a) prior to receiving the first qualifying parameter input via the player input system of the first gaming machine, displaying a tournament configuration interface at a display device of the tournament controller;
(b) receiving a player qualifying definition input through an operator input device of the tournament controller; and
(c) in response to the player qualifying definition input received through the operator input device of the tournament controller, storing the qualifying parameter definition in the first memory accessible to the tournament controller.

11. The method of claim 1 further including:
(a) at a second gaming machine, receiving a second qualifying parameter input via a player input system of the second gaming machine;
(b) in response to the second qualifying parameter input, making a second qualifying communication to the tournament controller included in the gaming system;
(c) with the tournament controller, determining if one or more qualifying parameter values associated with the second qualifying communication satisfy the qualifying parameter definition stored in the first memory accessible to the tournament controller;
(d) where the one or more qualifying parameter values associated with the second qualifying parameter input satisfy the qualifying parameter definition, placing the second gaming machine in the enabled state for the tournament game;
(e) conducting the tournament game through the second gaming machine to produce a tournament score for a player of the second gaming machine; and
(f) at the second memory assessible by the tournament controller, storing the tournament score for the player of the second gaming machine.
